(19) United States
(12) Patent Application Publication
(10) Pub. No.: US 2005/0024295 A1
(43) Pub. Date: Feb. 3, 2005

(54) Plasma display and method of driving a plasma display panel

(75) Inventor: Takashi Furutani, Tokyo (JP)

Correspondence Address: Paul J. Esatto, Jr.;Murphy & Presser, 400 Garden City Plaza, Garden City, NY, 11530, US

(73) Assignee: NEC Plasma Display Corporation

(21) Appl. No.: 10/899,649

(22) Filed: Jul. 27, 2004

(30) Foreign Application Priority Data
Jul. 28, 2003 (JP) 2003-281376

(51) Int. Cl. G09G 3/28

(52) U.S. Cl. 345/60

(57) ABSTRACT

In a plasma display panel, cells are disposed in a column direction and in a row direction in the form of a matrix, and electrodes are formed such that, in cells located in each column, a cell has a priming electrode (auxiliary electrode) electrically connected via an interconnection to a scan electrode of a cell at an upper adjacent location. This structure in terms of electrodes allows a write discharge to occur without fail in a reduced scanning period.

### BACKGROUND OF THE INVENTION

1. Field of the Invention

The present invention relates to a plasma display and a method of driving a plasma display panel (PDP), and more particularly, to a plasma display and a method of driving a PDP, capable of performing scanning in a reduced scan period.

2. Description of the Related Art

A plasma display using a PDP has many advantages over conventional displays such as a cathode ray tube (CRT) display or a liquid crystal display. That is, the plasma display can be produced in a very thin form having a large-size screen, and it can display a high-quality image with low flicker and high contrast at a high response speed. Because of its great advantages, the plasma display is widely used in many systems or apparatuses such as a flat television set, a computer, and various kinds of information processing equipment.

The plasma display can be roughly classified into two types according to the manner of operation. A first type is an AC plasma display in which a PDP has display electrodes (row electrodes each including scan electrodes and sustain electrodes) that are formed to be covered with a transparent dielectric layer such that an AC discharge occurs indirectly via the transparent dielectric layer. A second type is a DC plasma display in which display electrodes are exposed to discharge spaces, and a DC discharge occurs in discharge spaces in operation. The plasma display of the AC type has a rather simple structure, and a large screen size can be easily achieved. In this type of PDP, a front substrate (first substrate) and a rear substrate (second substrate) are formed of a transparent material such as glass and disposed so as to face each other via a space serving as a discharge space which is filled with a discharge gas and in which a plasma discharge occurs in operation.

In one type of AC plasma display, row electrodes (display electrodes) consisting of scan electrodes and a sustain electrode (common electrode) are formed on the inner surface of the front substrate, which is one of two substrates forming the discharge cell of the PDP, so as to extend in parallel in a row direction, and column electrodes consisting of data electrodes (address electrodes) are formed on the inner surface of the rear substrate, that is the other one of the two substrates, so as to extend in a column direction perpendicular to the row direction. This type of AC plasma display is known as a three-electrode surface discharge plasma display and has the advantage that when a surface discharge occurs on the inner surface of the front substrate, generated high-energy ions do not bombard a fluorescent layer formed on the inner surface of the rear substrate, and thus a long lifetime can be achieved. In the three-electrode surface discharge AC plasma display, if red, green, and blue fluorescent layers are disposed on the inner surface of the rear substrate of the PDP, a color plasma display is achieved.

FIG. 1 is a plan view showing a structure in terms of electrodes widely used in the PDP (denoted by 100 in FIG. 1) of the three-electrode surface discharge AC plasma display. In this structure in terms of electrodes of the PDP, as shown in FIG. 1, row electrodes (display electrodes) consisting of m scan electrodes 105 (S1, S2, S3, . . . , Sm) and a sustain electrode (common electrode) 106 (C) are formed on the inner surface of the front substrate so as to extend in parallel in a row direction H, and n column electrodes 113 (D1, D2, D3, . . . , Dn) serving as data electrodes (address electrodes) are formed on the inner surface of the rear substrate so as to extend in a column direction V perpendicular to the row direction H. One unit cell (hereinafter, also referred to simply as a cell) 130 is formed at each intersection of the row electrodes (each consisting of a scan electrode and a sustain electrode) and the column electrodes such that cells are arranged in the row direction H and the column direction V in the form of a matrix. In the case of a monochrome display, one pixel is formed by one cell. In the case of a color display, one pixel is formed by three cells (a red (R) cell, a green (G) cell, and a blue (B) cell). In this PDP, the scan electrode 105 and the sustain electrode 106 are disposed alternately, as shown in FIGS. 1 and 2. However, it is also known to form electrodes such that groups of a sustain electrode 106, a scan electrode 105, another scan electrode 105 and another sustain electrode 106 which are arranged in this order are disposed continuously, as shown in FIGS. 5 and 6.

FIG. 2 is a plan view partially showing the details of the electrodes of the PDP 100 shown in FIG. 1. In this figure, of many cells formed side by side in the column direction V, only three cells (n−1), n, and (n+1) are shown as examples. For example, the cell n at the central location includes three electrodes, that is, a scan electrode 105 (Sn), a sustain electrode 106 (C), and a data electrode 113 (Dm), wherein the scan electrode 105 (Sn) and the sustain electrode 106 (C) extend in parallel, and the data electrode 113 (Dm) extends in a direction perpendicular to the scan electrode 105 (Sn) and the sustain electrode 106 (C).

The PDP 100 can be driven, for example, using driving signals such as shown in FIG. 3, as described below. In the PDP, one full image is formed by one field that is displayed every field period (1/60 sec). As shown in FIG. 3, each field includes a plurality of subfields T1 by which to realize a gray-scale image as will be described in detail later. Each subfield T1 includes a pre-discharge period T2, a scan period T3, and a sustain period T4. In the process of driving the PDP, in each scan period T3, a scan pulse is applied to the respective scan electrode 105 formed on the front substrate, and, at the same time, data pulses P9 are applied to the data electrodes 113 formed on the rear substrate thereby causing a write discharge to occur in selected cells to be lit. In a subsequent sustain period T4, a sustain discharge in the form of a surface discharge occurs between the scan electrode 105 and the sustain electrode 106 in each selected cell. Whether or not such a discharge occurs is determined by whether a charge called a wall charge is accumulated on a transparent dielectric layer formed on the display electrodes on the front substrate. That is, the discharge is controlled by forming or removing the wall charge. Whether a particular cell will be lit or not lit depends on the voltage of the data pulse that is applied to the cell in the scan period T3 during which a write discharge occurs in a cell to be lit. For example, in the scan period T3 shown in FIG. 3, those cells that are applied with the data pulse P9 with a voltage of several tens volts are lit, while those cells that are applied with the data pulse with a voltage of 0 volts, that is, those cells that are applied with no data pulse are not lit.

In a subsequent sustain period T4, sustain pulses 10 are applied alternately to the scan electrodes 105 and the sustain electrodes 106 of all cells such that a sustain discharge occurs only in the cells that were lit in the scan period T3, thereby displaying an image. After completion of the sustain discharge, to make preparation for a write discharge in a pre-discharge period T2 of a subsequent subfield, a sustain release pulse P5 is applied to all lit cells so that a pre-discharge occurs in those cells and the wall charge formed in the sustain discharge is removed. In the pre-discharge period T2, in order to make it easy for a write discharge to occur in the subsequent scan period, a priming pulse P6 or P7 is applied to all cells so that a priming discharge occurs in each cell after the pre-discharge. Although in the above description, for the purpose of an easy understanding, the write discharge in the scan period T3 and the sustain discharge in the sustain period T4 have been discussed first before the discussion of the pre-discharge and the priming discharge in the pre-discharge period T2, discharges actually occur in each subfield T2 in the order shown in FIG. 3.

Referring to FIG. 4, a method of realizing a gray-scale image is described below. In the PDP, to realize a gray-scale image depending on the brightness level, each field T (62), during which one full image is displayed, is divided into a plurality of subfields, for example, eight subfields T63 to T70 as shown in FIG. 4. Each subfield T63 to T70 includes a pre-discharge period T2, a scan period T3, and a sustain period T4, as described above. The length of the sustain period varies depending on the subfields T63 to T70. In the example shown in FIG. 4, the lengths of the sustain periods are set at a ratio of 1:2:4:8:16:32:64:128. This setting of the lengths of the sustain periods allows each pixel to have one of luminance level in the range from a level of 0 to a level of 255. For example, a luminance level of 100 can be achieved by lighting a pixel in subfields with lengths of 4, 32, and 64. Although in this example, eight subfields are used to realize 256 gray levels, nine or more subfields may be used for redundancy.

When the PDP, which is the main part of the plasma display, is driven, it is desirable that as long a period as possible be assigned to the sustain period because the luminance of the screen is determined by the sustain period T4 (or the number of times discharges occur) of each subfield T1. However, in reality, the above requirement is difficult to meet because of a tendency of the PDP toward a greater screen size. With increasing screen size, the number of cells (pixels) increases. If the conventional structure and the convention driving method are used for a PDP having an increased number of cells, the ratio of the scan period T3 for the write discharge to the total period of one subfield T1 increases, and the increase in the scan period T3 causes the sustain period to decrease.

For example, in the case in which 256 gray levels are realized by using eight subfields as shown in FIG. 4 for a display screen with a resolution of XGA (Extended Video Graphics Array) (with 768 scan lines), if the scan pulse P8 needs a length of 2 μs for one write discharge, then the total length of scan period T3 per second (60 fields) is given by

$$\begin{matrix}T3 = 2 ( μs ) \times 768 ( scan lines ) \times 8 ( subfields ) \times 60 \\ \approx 0.7373 sec\end{matrix}$$

Thus, in this example, the scan period T3 occupies two thirds the one field. For a display screen with a lower distortion of VGA (Video Graphics Array) (with 480 scan lines), the scan period is calculated as T3≈0.4608 sec according to the above equation. From the above calculations, it can be seen that the ratio of the scan period T3 to the total period of one field greatly increases with increasing resolution. As a result, the period assigned to the sustain period T4 decreases, and thus it becomes impossible to achieve high enough luminance. In view of the above, in the PDP, there is a great need to reduce the scan period for the write discharge to achieve a higher resolution without causing a reduction in luminance or to achieve a higher luminance while maintaining the resolution.

To meet the above need, it has been proposed to reduce the pulse width of each scan pulse P8 for each write discharge thereby reducing the total scan period T3 and thus increasing the sustain period T4, by using the same structure of the PDP and the same driving method described above. However, in this technique, a write discharge failure can occur in some cells, and cells to be lit are not correctly lit. This results in degradation in image quality.

It has also been proposed to divide the screen of the PDP into upper and lower subscreens and dispose data electrodes separately in the upper and lower sunscreens. In this structure, scanning is performed independently in the upper and lower subscreens, and thus the scan period T3 can be reduced to one-half the period needed in the simple single screen structure. This method is known as a dual scan method. However, in this technique, although the scan period T3 can be reduced by half, a more complicated circuit is needed to drive the data electrodes, and thus higher cost is needed.

It has been also proposed to change the structure of the PDP and the method of driving the PDP in such a manner that makes it possible to reduce the pulse width of the scan pulse P8 thereby reducing the total scan period T3 (Japanese Unexamined Patent Application Publication No. 2002-297091). In this technique, as shown in FIG. 7A, the PDP is constructed such that first auxiliary discharge electrodes 114 and second auxiliary discharge electrodes 142 are formed on the inner surface of a front glass substrate 133 in addition to scan electrodes 111 and sustain electrodes 112 such that those electrodes extend in parallel. This PDP constructed in the above-described manner is driven such that an auxiliary discharge is generated between the auxiliary discharge electrodes 141 and 142 each time a scan pulse is applied to the scan electrode 111. As a result, as shown in FIG. 7B, a space charge is generated by the auxiliary discharge. Thereafter, as shown in FIG. 7C, when a scan pulse is applied to the scan electrode 111, if a data pulse is also applied to the data electrode 135, the space charge allows a write discharge to quickly occur.

In the conventional PDP and the method of driving the PDP disclosed in Japanese Unexamined Patent Application Publication No. 2002-297091 cited above, it is required to apply complicated driving signals to the first and second auxiliary discharge electrodes in addition to the other electrodes, a complicated driving circuit is needed, and thus an increase in cost occurs.

In the PDP and the method of driving the PDP disclosed in Japanese Unexamined Patent Application Publication No. 2002-297091, although it is possible to prevent a write discharge failure that can occur in particular cells in the conventional technique and it is possible to achieve a high-quality image without needing a complicated structure such as a structure including upper and lower subscreens, high cost is needed because of the provision of the first and second auxiliary discharge electrodes 141 and 142 and the complicated circuit for generating complicated driving signals for generating an auxiliary discharge between the auxiliary discharge electrodes 141 and 142.

### SUMMARY OF THE INVENTION

It is an object of the present invention to provide a plasma display and a method of driving a plasma display panel, capable of generating a write discharge in a highly reliable fashion in a reduced scan period thereby displaying a high-quality image without causing an increase in complexity of a driving circuit which would result in an increase in cost.

A plasma display according to a first aspect of the present invention comprises a plasma display panel comprising first and second substrates disposed so as to face each other via a discharge space filled with a discharge gas, row electrodes each including a scan electrode and a sustain electrode formed on the inner surface of the first substrate so as to extend in parallel in a row direction, data electrodes formed on the inner surface of the second substrate so as to extend in a column direction perpendicular to the row direction, and unit cells formed at respective intersections of the row electrodes and the column electrodes. At least one unit cell of the unit cells has an auxiliary electrode electrically connected to a scan electrode of another unit cell disposed in the same column as the column in which the at least one unit cell lies.

In a second aspect of the present invention, a plasma display may be provided, in which at least one unit cell of the unit cells has an auxiliary electrode electrically connected to a scan electrode of another unit cell adjacent in the column direction to the at least one unit cell.

In a third aspect of the present invention, a plasma display may be provided, in which each of the unit cells other than unit cells located in a top row has a scan electrode, a sustain electrode, a data electrode, and an auxiliary electrode.

In a fourth aspect of the present invention, a plasma display may be provided, in which, each of unit cells located in a top row has a scan electrode, a sustain electrode, a data electrode, and an auxiliary electrode, the auxiliary electrode being independent of any other electrode unlike the auxiliary electrode of unit cells other than those located in the top row.

In a fifth aspect of the present invention, a plasma display may be provided, in which a dielectric layer formed on the second substrate has a greater thickness at locations opposing the auxiliary electrodes formed on the first substrate than at locations opposing the scan electrodes formed on the first substrate.

In a sixth aspect of the present invention, a plasma display may be provided, in which a common cell electrode is formed, separately from the data electrode, in the dielectric layer at each location opposing each auxiliary electrode.

In a seventh aspect of the present invention, a plasma display may be provided, in which the auxiliary electrodes are formed such that a plurality of auxiliary electrodes extend from the scan electrode of one unit cell and extend into a plurality of other unit cells.

In an eighth aspect of the present invention, a plasma display may be provided, in which the auxiliary electrodes are formed of an opaque metal.

In a ninth aspect of the present invention, a plasma display may be provided, in which a light blocking member is provided on the upper side of the auxiliary electrodes.

A method of driving a plasma display panel according to the present invention is a method for driving a plasma display panel which comprises first and second substrates disposed so as to face each other via a discharge space filled with a discharge gas, row electrodes each including a scan electrode and a sustain electrode formed on the inner surface of the first substrate so as to extend in parallel in a row direction, data electrodes formed on the inner surface of the second substrate so as to extend in a column direction perpendicular to the row direction, and unit cells formed at respective intersections of the row electrodes and the column electrodes. At least one unit cell of the unit cells has an auxiliary electrode electrically connected to a scan electrode of another unit cell adjacent in the column direction to the at least one unit cell. The method includes the step of applying a scan pulse to a scan electrode such that the scan pulse applied to the scan electrode of a unit cell causes a voltage greater than a discharge firing voltage to be developed between the auxiliary electrode and one of electrodes of each of all unit cells whose auxiliary electrode is electrically connected to the cell whose scan electrode is applied with the scan pulse, regardless of whether or not a data pulse is applied to the data electrode.

A method of driving a plasma display panel according to another aspect of the present invention is a method for driving a plasma display panel which comprises first and second substrates disposed so as to face each other via a discharge space filled with a discharge gas, row electrodes each including a scan electrode and a sustain electrode formed on the inner surface, facing the second substrate, of the first substrate so as to extend in parallel in a row direction, data electrodes formed on the inner surface, facing the first substrate, of the second substrate so as to extend in a column direction perpendicular to the row direction, and unit cells formed at respective intersections of the row electrodes and the column electrodes. At least one unit cell of the unit cells has an auxiliary electrode electrically connected to a scan electrode of another unit cell adjacent in the column direction to the at least one unit cell. The method includes the step of scanning an arbitrary row by applying a scan pulse to a scan electrode in the row such that the scan pulse applied to the scan electrode of a unit cell causes a voltage greater than a discharge firing voltage to be developed between the auxiliary electrode and one of electrodes of each unit cell whose auxiliary electrode is electrically connected to the cell whose scan electrode is applied with the scan pulse, regardless of whether or not a data pulse is applied to the data electrode.

In the above-noted method of driving a plasma display panel, the discharge firing voltage between an auxiliary electrode and a corresponding data electrode may be smaller than the discharge firing voltage between a scan electrode and a corresponding data electrode.

In the method of driving a plasma display panel, the voltage of the scan pulse is set such that the scan pulse applied to the scan electrode of a unit cell causes a discharge to occur between the auxiliary electrode and one of electrodes of each of all unit cells whose auxiliary electrode is electrically connected to the cell whose scan electrode is applied with the scan pulse, regardless of whether or not a data pulse is applied to the data electrode.

The method of driving a plasma display panel according to the present invention may be constructed as follows. Namely, the rows may be grouped into a plurality of groups each including two or more scan rows in the row direction such that in any block, a scan electrode in a row to which data is written first of all rows in the block functions not only as a write electrode for writing data in that row but also as an auxiliary electrode for cells in all rows in the block.

Also, a scan pulse may be applied to a scan electrode connected to an auxiliary electrode for a longer period than is applied to a scan electrode in a block in which the auxiliary electrode lies.

In the plasma display and the method of driving the PDP according to the present invention, as described above, a cell of interest, for example, a cell n, is lit via the process involving applying a scan pulse P8 such that when the scan pulse P8 is applied to a scan electrode 5 (Sn−1) of another cell (n−1) adjacent in the column direction V to the cell n, the scan pulse P8 is also applied to a priming electrode 17 (Sn−1′) of the cell n, and then simultaneously applying the scan pulse P8 and data pulse P9 to a scan electrode 5 (Sn) and a data electrode 13 (D) of the cell n, such that a voltage greater than the discharge firing voltage is developed between the scan electrode 5 (Sn) and the data electrode 13 (D) thereby causing a write discharge to occur in the cell n. By driving the cell n in the above described manner, the write discharge for the cell n can be quickly performed.

### BRIEF DESCRIPTION OF THE DRAWINGS

FIG. 1 is a plan view showing a structure in terms of electrodes of a conventional PDP;

FIG. 2 is a plan view showing the details of some electrodes of the conventional PDP;

FIG. 3 is a diagram showing the waveforms of pulse signals used to drive a PDP according to a conventional technique;

FIG. 4 is a diagram showing a method of driving a PDP according to a conventional technique;

FIG. 5 is a plan view showing another structure in terms of electrodes of a conventional PDP;

FIG. 6 is a plan view showing the details of some electrodes of the conventional PDP;

FIGS. 7A to 7C are diagrams showing a conventional PDP and a method of driving the PDP according to a conventional technique;

FIG. 8 is a perspective view of a PDP that is a main part of a plasma display according to a first embodiment of the present invention;

FIG. 9 is a cross-sectional view taken along line A-A of FIG. 8;

FIG. 10 is a cross-sectional view taken along line B-B of FIG. 8;

FIG. 11 is a plan view showing some electrodes of the PDP;

FIGS. 12A to 12C are side views showing a method of driving a PDP;

FIG. 13 is a diagram partially showing the waveforms of pulse signals used to drive a PDP according to a first, second, or third embodiment of the present invention;

FIGS. 14A to 14C are side views showing the structure of a PDP that is a main part of a plasma display and also showing a method of driving the PDP, according to a second embodiment of the present invention;

FIG. 15 is a side view showing the structure of a PDP that is a main part of a plasma display according to a third embodiment of the present invention;

FIG. 16 is a plan view showing the structure of a PDP that is a main part of a plasma display according to a fourth embodiment of the present invention;

FIG. 17 is a cross-sectional view of a PDP according to the fourth embodiment of the present invention;

FIG. 18 is a diagram partially showing the waveforms of pulse signals used to drive a PDP according to a fourth, fifth, or sixth embodiment of the present invention;

FIG. 19 is a side view showing a modification of the PDP according to the fourth embodiment of the present invention;

FIG. 20 is a side view showing the structure of a PDP that is a main part of a plasma display according to a fifth embodiment of the present invention;

FIG. 21 is side view showing a modification of the PDP according to the fifth embodiment of the present invention;

FIG. 22 is a side view showing the structure of a PDP that is a main part of a plasma display according to a sixth embodiment of the present invention;

FIG. 23 is side view showing a modification of the PDP according to the sixth embodiment of the present invention;

FIG. 24 is a plan view showing the structure of a PDP that is a main part of a plasma display according to a seventh embodiment of the present invention;

FIG. 25 is a cross-sectional view of the PDP according to the seventh embodiment of the present invention;

FIG. 26 is a diagram partially showing the waveforms of pulse signals used to drive a PDP according to a seventh, eighth, or ninth embodiment of the present invention;

FIG. 27 is a side view showing a modification of the PDP according to the seventh embodiment of the present invention;

FIG. 28 is a side view showing the structure of a PDP that is a main part of a plasma display according to an eighth embodiment of the present invention;

FIG. 29 is a side view showing the structure of a PDP that is a main part of a plasma display according to a ninth embodiment of the present invention;

FIG. 30 is a perspective view showing a modified structure of a PDP according to the present invention;

FIG. 31 is a cross-sectional view taken along line C-C of FIG. 30;

FIG. 32 is a cross-sectional view taken along line D-D of FIG. 30; and

FIG. 33 is a diagram showing the waveforms of pulse signals used to drive a PDP according to the present invention.

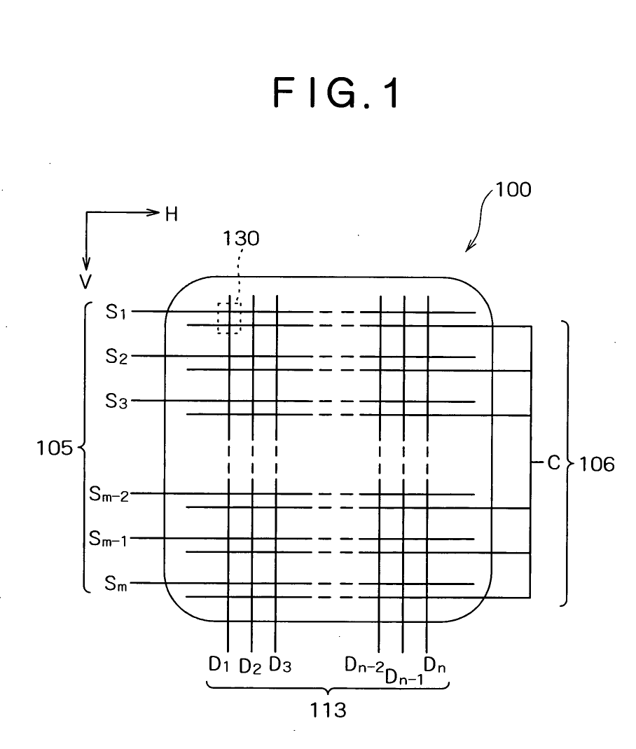

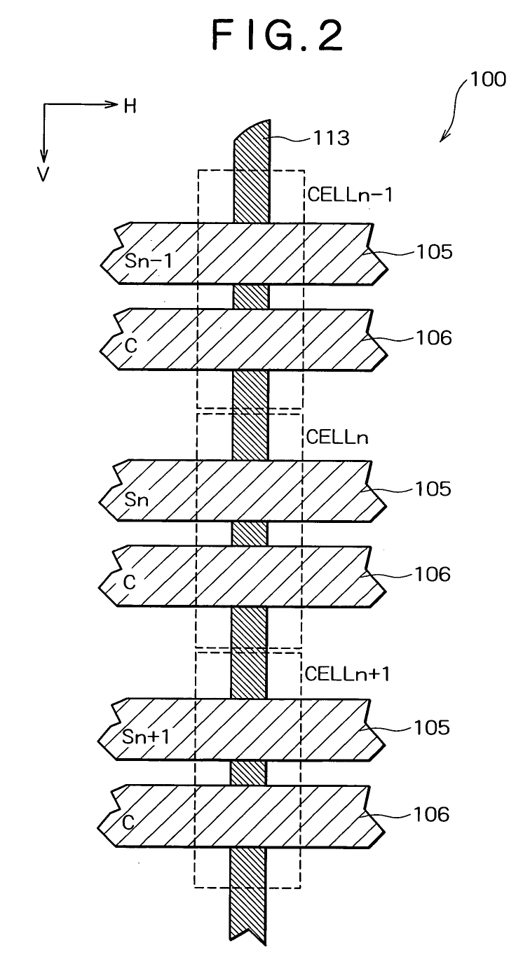

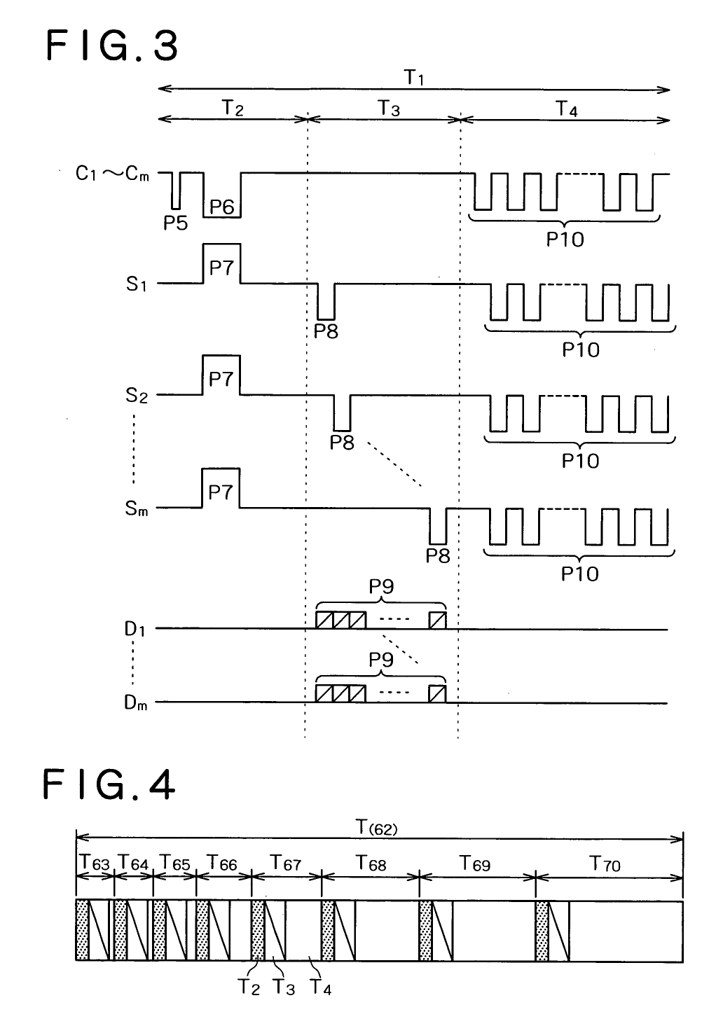

### DETAILED DESCRIPTION OF THE PREFERRED EMBODIMENTS

When scanning pulses are applied to cells during a scan period, the voltage applied between a scanning electrode and a data electrode is set to be greater than a discharge firing voltage regardless of whether a data pulse is applied to the data electrode. If the voltage is set in the above described manner, when data pulses are applied to cells to be lit, a strong discharge functioning as a write discharge occurs in each cell to be lit, and a large amount of wall charge is accumulated on the transparent dielectric layer. In a sustain period following the scan period, a sustain discharge is performed in each cell being lit. On the other hand, no data pulse is applied to cells not to be lit, and thus no strong discharge occurs although the voltage greater than the discharge firing voltage is applied. Therefore, no large amount of wall charge is accumulated on the transparent dielectric layer, and thus, in the non-lit cells, no sustain discharge occurs during the sustain period following the scan period.

[First Embodiment]

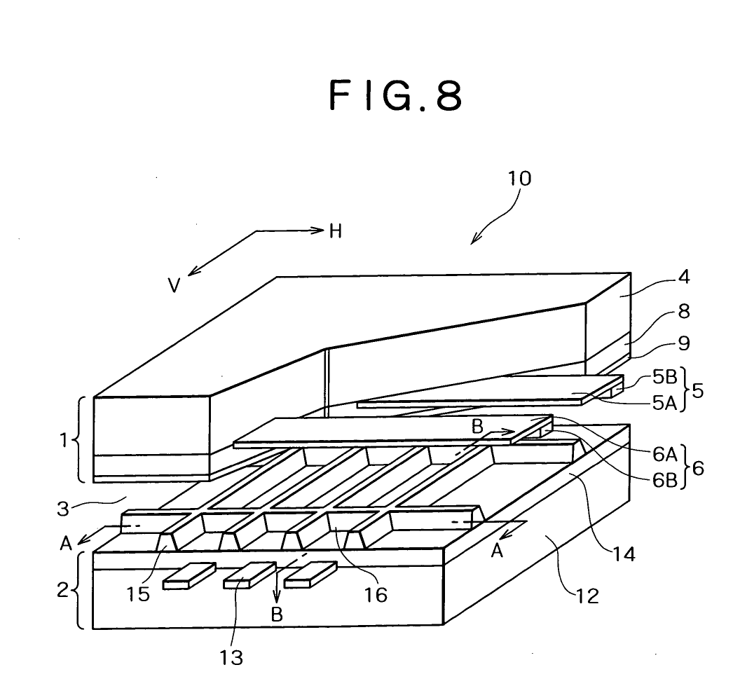

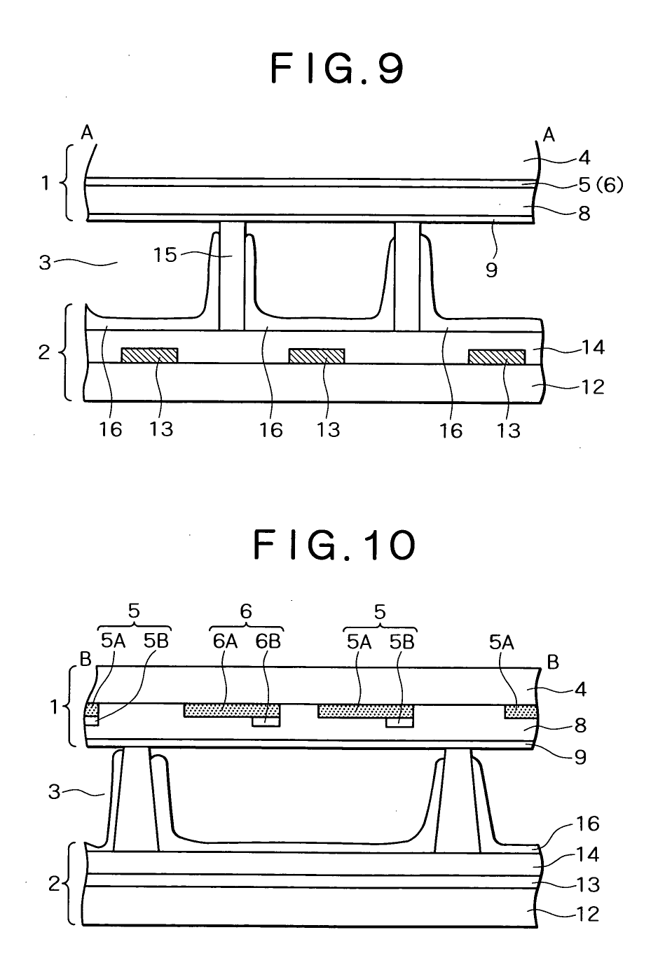

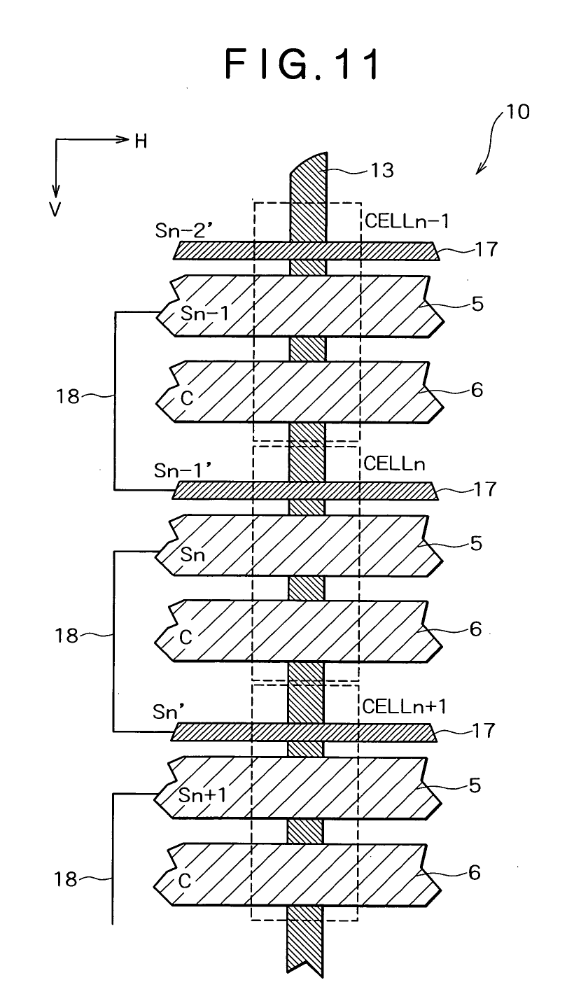

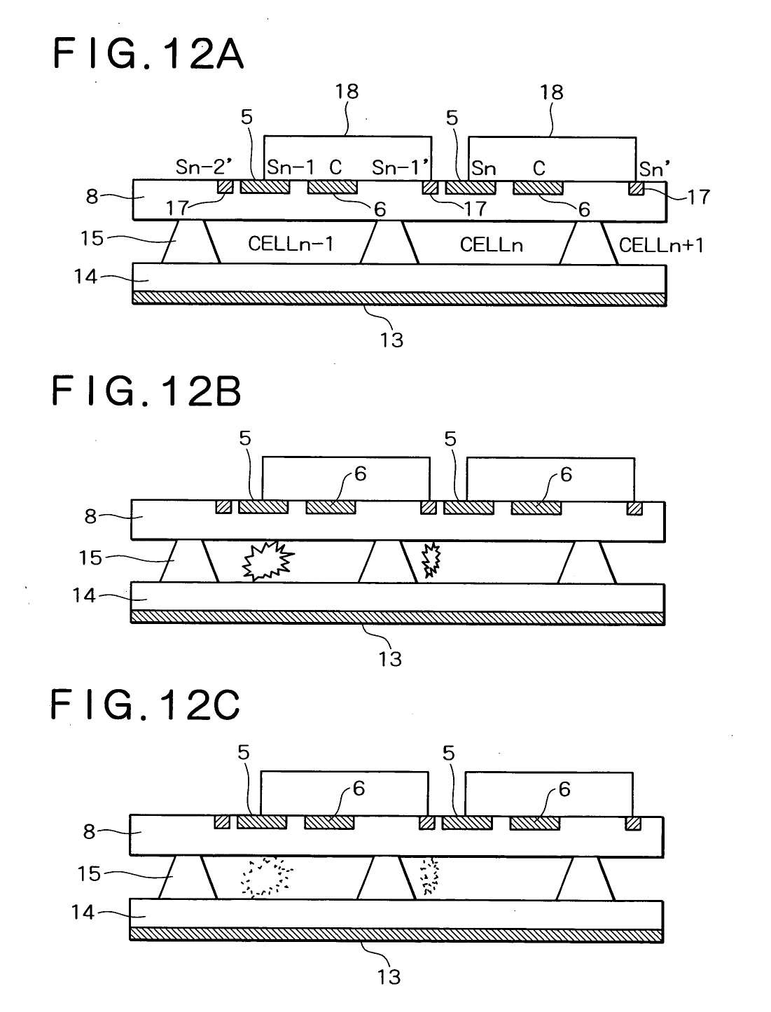

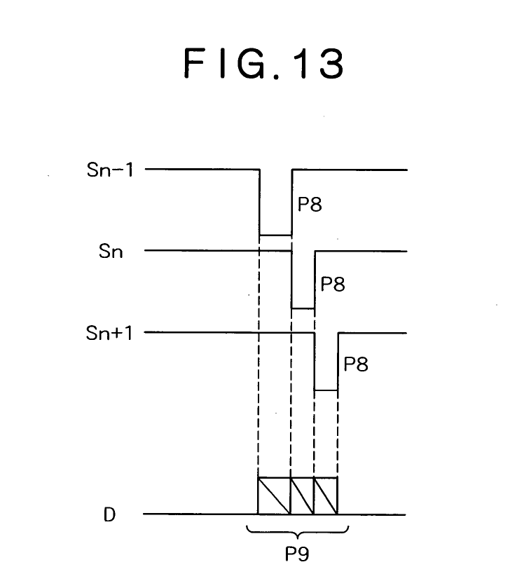

FIG. 8 is a perspective view of a PDP that is a main part of a plasma display according to a first embodiment of the present invention. FIG. 9 is a cross-sectional view taken along line A-A of FIG. 8. FIG. 10 is a cross-sectional view taken along line B-B of FIG. 8. FIG. 11 is a plan view showing some electrodes of the PDP. FIGS. 12A to 12C are side views showing a method of driving the PDP. FIG. 13 is a diagram partially showing the waveforms of pulse signals used to drive the PDP according to the first embodiment of the present invention, wherein the same waveforms are also used in second and third embodiments described later.

In this first embodiment, as shown in FIGS. 8 to 10, the PDP 10, which is the main part of the plasma display, includes a front substrate (first substrate) 1 and a rear substrate (second substrate) 2, which are disposed so as to face each other. A discharge space 3 is formed between the front substrate 1 and the rear substrate 2, and the discharge space 3 is filled with a discharge gas.

The front substrate 1 includes a first insulating substrate 4 formed of a transparent material such as soda-lime glass with a thickness of 2 to 5 nm, scanning electrodes 5, sustain electrodes (common electrodes) 6, a transparent dielectric layer 8 formed of low-melting lead glass or the like with a thickness of 20 to 40 μm so as to cover row electrodes including the scanning electrodes 5 and the sustain electrodes 6, and a protective layer 9 formed of MgO (magnesium oxide) or the like with a thickness of 0.5 to 2.0 μm for protecting the transparent dielectric layer 8 from a discharge, wherein each scanning electrode 5 includes a transparent electrode 5A formed of ITO (Indium Tin Oxide) or tin oxide (SnO2) or the like with a thickness of 100 to 500 nm and a bus electrode (trace electrode) 5B formed of a metallic material such as Ag (silver), Al (aluminum), or a multilayer thin film Cr (chromium)/Cu (copper)/Cr (Chromium) disposed so as to partially cover the transparent electrode 5A thereby reducing the resistance of the scanning electrode 5, and wherein each sustain electrode 6 includes a transparent electrode 6A formed of ITO (Indium Tin Oxide) or tin oxide (SnO2) or the like with a thickness of 100 to 500 nm and a bus electrode (trace electrode) 6B formed of a metallic material such as Ag (silver), Al (aluminum), or a multilayer thin film Cr (chromium)/Cu (copper)/Cr (Chromium) disposed so as to partially cover the transparent electrode 6A thereby reducing the resistance of the sustain electrode 6.

The transparent dielectric layer 8 is formed by first coating a low-melting lead glass paste or the like so as to cover the row electrodes and then baking the paste at a temperate higher than the melting point of the paste. The protective layer 9 servers to form wall charge necessary for discharging and is formed by sputtering or evaporating MgO or the like.

The rear substrate 2 includes a second insulating substrate 12 formed of a transparent material such as soda-lime glass with a thickness of 2 to 5 nm, data electrodes (address electrodes) 13 formed of Ag, Al, Cu, or the like with a thickness 2 to 4 μm disposed on the inner surface of the second insulating substrate 12 so as to extend in a column direction V perpendicular to a row direction H, a white dielectric layer 14 formed of low-melting lead glass or the like containing a white pigment with a thickness of 5 to 40 μm covering the data electrodes 13, partition walls 15 constructed by forming walls of fritted glass containing lead in the column direction V and in the row direction H such that the discharge space 3 filled with a mixed gas serving as a discharge gas including He (helium), Ne (neon), Ar (argon), Kr(krypton), Xe (xenon), N2 (nitrogen), O2 (oxygen), and/or CO2 (carbon dioxide) is divided into discharge cells enclosed by partition walls, and a fluorescent layer 16 formed so as to cover the bottom surface and side faces of the partition walls 15, for converting ultraviolet light generated by a discharge of the discharge gas into visible light.

The white dielectric layer 14 is formed by first coating a low-melting glass paste containing titanium oxide powder or alumina powder serving as a white pigment so as to cover the data electrodes 13 and then baking it. The partition walls 15 are formed by means of screen printing or sandblasting using a fritted glass paste containing lead. The fluorescent layer 16 is formed by coating a paste containing a fluorescent material by means of screen printing or the like and then baking the paste. If the fluorescent layer 16 is formed such that different fluorescent materials capable of emitting fluorescent light of respective three primary colors (red, green, and blue colors) are used depending on cells, a color PDP can be achieved.

The front substrate 1 and the rear substrate 2 are bonded together using a sealing material such that they face each other via a gap and then subjected to baking at 300 to 500° C. Thereafter, the discharge space 3 is evacuated and filled with a discharge gas with a pressure of 200 to 700 Torr (Torricelli). Thus, a complete PDP 10 is obtained.

In the present embodiment, the electrodes of the PDP 10 are disposed as shown in FIG. 11. In FIG. 11, of many cells disposed side by side in the column direction V, only three cells denoted by (n−1), n, and (n+1) are shown as examples. The cell n located in the center in FIG. 11 has a priming electrode (auxiliary electrode) 17 (Sn−1′) electrically connected via an interconnection 18 to a scan electrode 5 (Sn−1) of the cell (n−1) at an upper adjacent location. Similarly, the cell (n+1) at a lower adjacent location has a priming electrode (auxiliary electrode) 17 (Sn′) electrically connected via an interconnection 18 to a scan electrode 5 (Sn) of the cell n upwardly adjacent to the cell (n+1). That is, in the PDP 10 according to the present embodiment, the scan electrode 5 of each of the cells disposed side by side in the column direction V includes a part extending into an adjacent cell.

As described above, in the PDP 10 according to the present embodiment, the first substrate 1 and the second substrate 2 are disposed so as to face each other via the discharge space 3 filled with the discharge gas, row electrodes each including a scan electrode 5 and a sustain electrode 6 are formed on the inner surface of the first substrate 1 so as to extend in parallel in the row direction, data electrodes 13 are formed on the inner surface of the second substrate 2 so as to extend in the column direction perpendicular to the row direction, and unit cells are formed at respective intersections of the row electrodes and the column electrodes such that at least one cell n of those cells has a priming electrode 17 (Sn−1′) electrically connected to a scan electrode 5 (Sn−1) of another cell (n−1) at a location adjacent in the column direction V. This simple structure makes it possible for a write discharge to quickly occur in a desired cell, as will be described in further detail later.

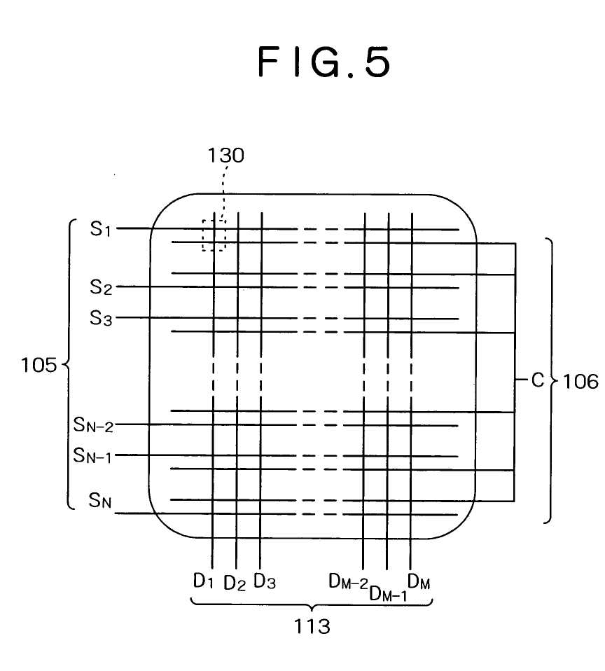

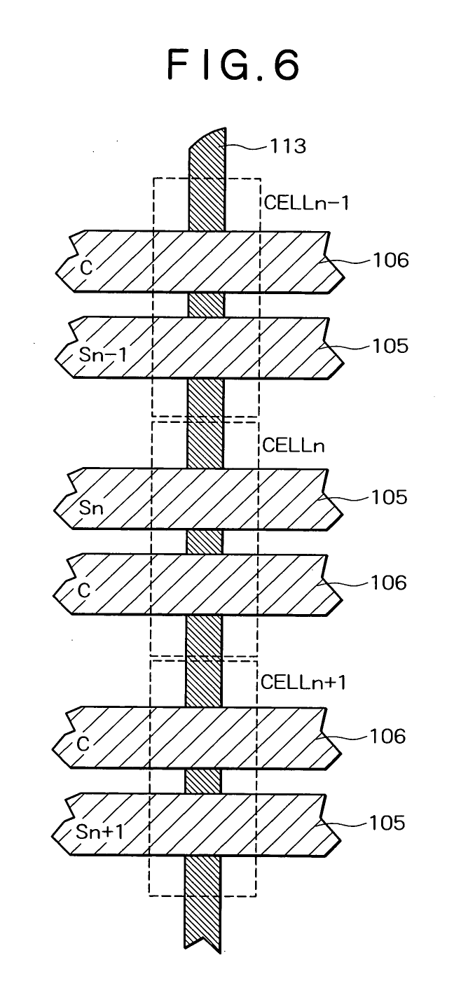

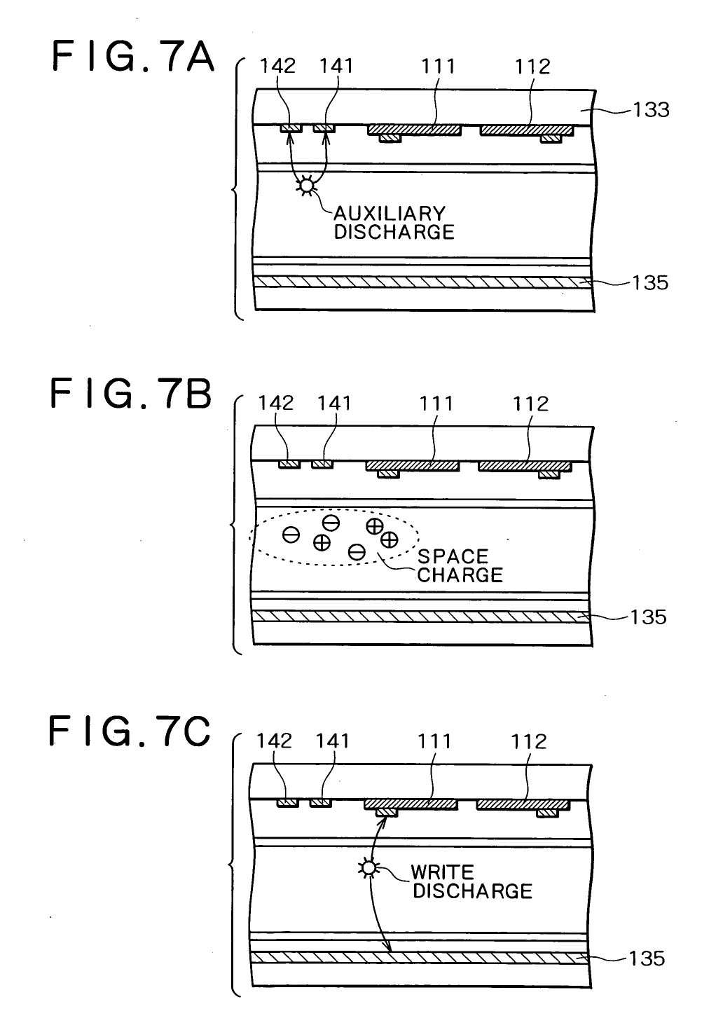

Referring to FIGS. 12 and 13, a method of driving the PDP according to the present embodiment is described below. Note that FIG. 13 shows driving signals only for a scan period (driving signals over a full subfield period is shown in FIG. 5). In this method of driving the PDP, as will be described in further detail later, when scanning pulses are applied to cells during a scan period, the voltage applied between a scanning electrode and a data electrode is set to be greater than a discharge firing voltage regardless of whether a data pulse is applied to the data electrode. In the state in which the voltage is set in the above-described manner, when data pulses are applied to cells to be lit, a strong discharge functioning as a write discharge occurs in each cell, and a large amount of wall charge is accumulated on the transparent dielectric layer. In a sustain period following the scan period, the accumulated wall charge allows a sustain discharge to occur in each cell being lit. On the other hand, no data pulse is applied to cells not to be lit, and thus no strong discharge occurs although the voltage greater than the discharge firing voltage is applied. Therefore, no large amount of wall charge is accumulated on the transparent dielectric layer, and thus, in the non-lit cells, no sustain discharge occurs during the sustain period following the scan period. The write discharge process in a scan period is described below, taking the cell n as an example.

(1) When the cell (n−1) and the cell n are lit, the process is performed as follows.

As shown in FIG. 12A, in the PDP having electrodes disposed in such a manner as shown in FIG. 11, if a scan pulse P8 and a data pulse P9 shown in FIG. 13 are simultaneously applied to a scan electrode 5 (Sn−1) and a data electrode 13 (D), respectively, both coupled to the cell (n−1), a large discharge occurs in the discharge space 3 in the cell (n−1) as shown in FIG. 12B, and thus a write discharge occurs and the cell (n−1) is lit. Because the scan pulse P8 applied to the scan electrode 5 (Sn−1) is also applied to a priming electrode 17 (Sn−1′) connected to the cell n, a discharge also occurs in the discharge space 3 in the cell n as shown in FIG. 12B. However, because this discharge is weak, no write discharge occurs in the cell n at this stage. Subsequently, as shown in FIG. 13, if the scan pulse P8 and the data pulse P9 shown in FIG. 13 are simultaneously applied to a scan electrode 5 (Sn) and the data electrode 13 (D), respectively, both coupled to the cell n, a strong discharge occurs in the cell n and thus a write discharge occurs and the cell n is lit. When the write discharge occurs in the cell n at this stage, the scan pulse P8 already applied to the priming electrode 17 (Sn−1′) develops a voltage greater than the discharge firing voltage between the scan electrode 5 (Sn) and the data electrode 13 (D), and the voltage functions as a priming voltage that causes a priming discharge to occur. Thus, the write discharge in the cell n starts quickly. Therefore, even if the scan pulse P8 has a small pulse width, the write discharge can certainly occur in the cell n. This allows the scan period to be reduced. More specifically, for example, the width of the scan pulse P8 can be reduced from 2 μs, which is a currently widely used value, to about 1.5 μs.

(2) When the cell (n−1) is lit but the cell n is not lit, the process is performed as follows.

If the cell (n−1) is driven in a similar manner as described in (1), a large discharge occurs in the discharge space 3 in the cell (n−1) as shown in FIG. 12B, and thus a write discharge occurs and the cell (n−1) is lit. In the cell n, at the same time, a weak discharge occurs as shown in FIG. 12B in a similar manner as described in (1). However, unlike the process described in (1), the data pulse P9 is not applied to the data electrode 13 (D) of the cell n. Therefore, although a voltage greater than the discharge firing voltage is applied between the scan electrode 5 (Sn) and the data electrode 13 (D), the cell n remains in the weak discharge state and the write discharge does not occur. As a result, the cell n is not lit.

(3) When the cell (n−1) is not lit but the cell n is lit, the process is performed as follows.

When the scan pulse P8 is applied to the scan electrode 5 (Sn−1) of the cell (n−1), if the data pulse P9 is not applied to the data electrode 13 (D), the cell (n−1) is brought into a weak discharge start state in which the cell (n−1) is not lit, as shown in FIG. 12C. In this state, it needs a long time to start a discharge, and thus the voltage applied to the cell n via the priming electrode 17 does not cause a priming discharge to occur within the period assigned to the scan pulse P8. However, although the priming discharge does not occur, the scan pulse P8 applied to the priming electrode 17 causes the cell n to be brought into the weak discharge start state as shown in FIG. 12C. Thereafter, as shown in FIG. 13, if the scan pulse P8 and the data pulse P9 are simultaneously applied to the scan electrode 5 (Sn) and the data electrode 13 (D), respectively, both coupled to the cell n, then a total of two successive pulses, that is, the previous scan pulse P8 and the current scan pulse P8, are applied to the cell n, and a voltage greater than the discharge firing voltage is developed between the scan electrode 5 (Sn) and the data electrode 13 (D). As a result, a strong discharge occurs in the cell n, and thus a write discharge occurs and the cell n is lit. In this write discharge in the cell n, the application of two successive pulses to the cell n allows the write discharge to quickly occur. Therefore, even if the scan pulse P8 has a small pulse width, the write discharge can occur in the cell n without fail. This allows the scan period to be reduced.

(4) When the cell (n−1) and the cell n are not lit, the process is performed as follows.

When the scan pulse P8 is applied to the scan electrode 5 (Sn−1) of the cell (n−1), if the data pulse P9 is not applied to the data electrode 13 (D), the cell (n−1) is not lit. Similarly, when the scan pulse P8 is applied to the scan electrode 5 (Sn) of the cell n, if the data pulse P9 is not applied to the data electrode 13 (D), the cell n is also not lit.

After the cell n is lit via the process (1) or (3) described above, the large amount wall charge accumulated on the transparent dielectric layer allows a sustain discharge to occur in the following sustain period. Thus, an image is displayed.

In the method of driving the PDP 10 according to the present embodiment, as described above with specific examples of processes (1) and (3), a cell of interest, for example, a cell n, is lit via the process involving applying a scan pulse P8 such that when the scan pulse P8 is applied to a scan electrode 5 (Sn−1) of another cell (n−1) adjacent in the column direction V to the cell n, the scan pulse P8 is also applied to a priming electrode 17 (Sn−1′) of the cell n, and then simultaneously applying the scan pulse P8 and data pulse P9 to a scan electrode 5 (Sn) and a data electrode 13 (D) of the cell n, such that a voltage greater than the discharge firing voltage is developed between the scan electrode 5 (Sn) and the data electrode 13 (D) thereby causing a write discharge to occur in the cell n. By driving the cell n in the above described manner, the write discharge for the cell n can be quickly performed.

Furthermore, in the plasma display including, as its main part, the PDP 10 according to the present embodiment, the first substrate 1 and the second substrate 2 are disposed so as to face each other via the discharge space 3 filled with the discharge gas, row electrodes each including a scan electrode 5 and a sustain electrode 6 are formed on the inner surface of the first substrate 1 so as to extend in parallel in the row direction, data electrodes 13 are formed on the inner surface of the second substrate 2 so as to extend in the column direction perpendicular to the row direction, and unit cells formed at respective intersections of the row electrodes and the column electrodes such that at least one cell n of those cells has a priming electrode 17 (Sn−1′) electrically connected to a scan electrode 5 (Sn−1) of another cell (n−1) at a location adjacent in the column direction V. This simple structure makes it possible to quickly perform a write discharge in the cell n.

Thus, the write discharge can be performed in a reduced scan period without needing a special expensive driving circuit, and a high-quality image can be displayed.

[Second Embodiment]

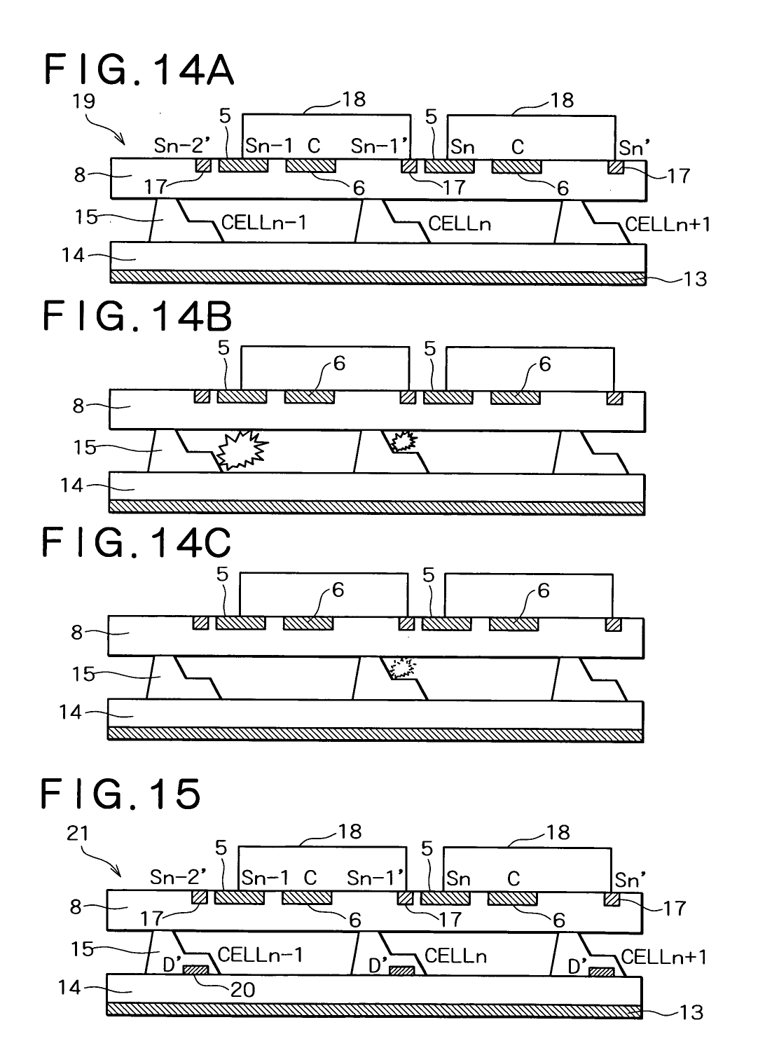

FIGS. 14A to 14C are side views showing the structure of a PDP that is a main part of a plasma display and also showing a method of driving the PDP, according to a second embodiment of the present invention. The structure of the PDP according to the present embodiment is essentially different from that according to the first embodiment in that the white dielectric layer formed on the rear substrate has a small thickness at locations corresponding to the scan electrodes formed on the front substrate and has a large thickness at locations corresponding to the priming electrodes formed on the front substrate.

More specifically, in the PDP 19 according to the present embodiment, as shown in FIG. 14A, the white dielectric layer 14 is formed on the back surface 2 such that its thickness is greater at locations opposing the priming electrodes 17 (Sn−2′), 17 (Sn−1′), and 17 (Sn′) of the respective three cells (n−1), (n), and (n+1), than is at locations opposing the scan electrodes 5 (Sn−1), 5 (Sn), and 5 (Sn−1), formed on the first insulating substrate 8 of the front substrate 1, of the respective three cells (n−1), (n), and (n+1). Note that the thickness of the white dielectric layer 14 includes the thickness of a part of the partition wall 15 formed of a similar material. Also note that the structure of the cell (n+1) is partially shown in FIG. 14. The setting of the thickness in the above-described manner causes the discharge firing voltage to vary depending on the location. That is, a small discharge firing voltage is achieved at locations at which the white dielectric layer 14 has the larger thickness corresponding to the priming electrodes 17 (Sn−2′), 17 (Sn−1′), and 17 (Sn′), compared with the discharge firing voltage at the other locations. More specifically, to achieve the object of the invention, the gap is designed such that in a state in which a scan pulse is applied but no data pulse is applied, no discharge occurs between a scan electrode and a data electrode of a cell although a voltage greater than the discharge firing voltage is developed between the scan electrode and the data electrode.

Referring to FIG. 14, a method of driving the PDP according to the present embodiment is described below. In this embodiment, the driving signals shown in FIG. 13 are also used to drive the PDP, as in the first embodiment described above. The write discharge process in a scan period is described below, taking the cell n as an example.

(1) When the cell (n−1) and the cell n are lit, the process is performed as follows.

If a scan pulse P8 and a data pulse P9 shown in FIG. 13 are simultaneously applied to a scan electrode 5 (Sn−1) and a data electrode 13 (D), respectively, both coupled to the cell (n−1), a large discharge occurs in the discharge space 3 in the cell (n−1) as shown in FIG. 14B, and thus a write discharge occurs and the cell (n−1) is lit. Because the scan pulse P8 applied to the scan electrode 5 (Sn−1) is also applied to a priming electrode 17 (Sn−1′) connected to the cell n, a weak discharge occurs in the discharge space 3 in the cell n as shown in FIG. 14B. Subsequently, as shown in FIG. 13, if the scan pulse P8 and the data pulse P9 are simultaneously applied to the scan electrode 5 (Sn) and the data electrode 13 (D), respectively, both coupled to the cell n, a strong discharge occurs in the cell n and thus a write discharge occurs and the cell n is lit. When the write discharge occurs in the cell n at this stage, the scan pulse P8 already applied to the priming electrode 17 (Sn−1′) develops a voltage greater than the discharge firing voltage between the scan electrode 5 (Sn) and the data electrode 13 (D), and the voltage functions as a priming voltage that causes a priming discharge to occur. Thus, the write discharge in the cell n starts quickly. Therefore, even if the scan pulse P8 has a small pulse width, the write discharge can certainly occur in the cell n. This allows the scan period to be reduced.

(2) When the cell (n−1) is lit but the cell n is not lit, the process is performed as follows.

If the cell (n−1) is driven in a similar manner as described in (1), a large discharge occurs in the discharge space 3 in the cell (n−1) as shown in FIG. 14B, and thus a write discharge occurs and the cell (n−1) is lit. In the cell n, at the same time, a weak discharge occurs as shown in FIG. 14B in a similar manner as described in (1). However, unlike the process described in (1), the data pulse P9 is not applied to the data electrode 13 (D) of the cell n. Therefore, although a voltage greater than the discharge firing voltage is applied between the scan electrode 5 (Sn) and the data electrode 13 (D), the cell n remains in the weak discharge state and the write discharge does not occur. As a result, the cell n is not lit.

(3) When the cell (n−1) is not lit but the cell n is lit, the process is performed as follows.

When the scan pulse P8 is applied to the scan electrode 5 (Sn−1) of the cell (n−1), if the data pulse P9 is not applied to the data electrode 13 (D), the cell (n−1) is not lit as shown in FIG. 14C. On the other hand, the scan pulse P8 applied to the priming electrode 17 causes the cell n to be brought into a weak discharge start state as shown in FIG. 14C. In this state, it needs a long time to start a discharge, and thus the voltage applied to the cell n via the priming electrode 17 does not cause a priming discharge to occur in the period assigned to the scan pulse P8. However, although a priming discharge does not occur, the scan pulse P8 applied to the priming electrode 17 causes the cell n to be brought into a weak discharge start state as shown in FIG. 14C. Subsequently, as shown in FIG. 13, if the scan pulse P8 and the data pulse P9 are simultaneously applied to the scan electrode 5 (Sn) and the data electrode 13 (D), respectively, both coupled to the cell n, a total of two successive pulses, that is, the previous scan pulse P8 and the current scan pulse P8, are applied to the cell n, and a voltage greater than the discharge firing voltage is developed between the scan electrode 5 (Sn) and the data electrode 13 (D). As a result, a strong discharge occurs in the cell n and a write discharge occurs. Thus the cell n is lit. In this write discharge in the cell n, the application of two successive pulses to the cell n allows the write discharge to quickly occur. Therefore, even if the scan pulse P8 has a small pulse width, the write discharge can certainly occur in the cell n. This allows the scan period to be reduced.

(4) When the cell (n−1) and the cell n are not lit, the process is performed as follows.

When the scan pulse P8 is applied to the scan electrode 5 (Sn−1) of the cell (n−1), if the data pulse P9 is not applied to the data electrode 13 (D), the cell (n−1) is not lit. Similarly, when the scan pulse P8 is applied to the scan electrode 5 (Sn) of the cell n, if the data pulse P9 is not applied to the data electrode 13 (D), the cell n is also not lit.

The other parts are similar to those of the first embodiment, and thus, in FIG. 14, similar parts to those in FIG. 12 are denoted by similar reference numerals and are not described in further detail herein.

After the cell n is lit via the process (1) or (3) described above, as in the first embodiment, the large amount wall charge accumulated on the transparent dielectric layer allows a sustain discharge to occur in the following sustain period. Thus, an image is displayed.

As described above, the second embodiment also provides effects and advantages similar to those achieved by the first embodiment.

[Third Embodiment]

FIG. 15 is a side view showing the structure of a PDP that is a main part of a plasma display according to a third embodiment of the present invention. The structure of the PDP according to the present embodiment is essentially different from that according to the second embodiment in that each cell has a common cell electrode disposed on the white dielectric layer on the rear substrate, at a location corresponding to the priming electrode of each cell.

That is, in the PDP 21 according to the present embodiment, as shown in FIG. 15, the white dielectric layer 14 is formed in a similar manner to the second embodiment such that the thickness of the white dielectric layer 14 is greater at locations opposing the priming electrodes 17 (Sn−2′), 17 (Sn−1′), and 17 (Sn′) of the respective three cells (n−1), (n), and (n+1), than is at locations opposing the scan electrodes 5 (Sn−1), 5 (Sn), and 5 (Sn−1), formed on the first insulating substrate 8 of the front substrate 1, of the respective three cells (n−1), (n), and (n+1). In addition, common cell electrodes 20 are formed on the white dielectric layer 14 at locations corresponding to the respective priming electrodes 17 (Sn−2′), 17 (Sn−1′), and 17 (Sn′). The common cell electrodes 20 are connected to a single power supply. The driving signals shown in FIG. 13 are also used to drive the PDP according to the present embodiment.

In the PDP constructed in the above-described manner according to the present embodiment, the voltage between the priming electrode 17 and the common cell electrode 20 is constant regardless of whether the data pulse is applied to the data electrode 13. Therefore, if a proper voltage is applied to the common cell electrode 20, a priming discharge occurs without fail regardless of whether the data pulse is applied to the data electrode 13. If the voltage applied to the common cell electrode 20 is set to be small enough such that the overall voltage of the scan pulse and the voltage applied to the common cell electrode 20 superimposed on the scan pulse becomes slightly greater than the discharge firing voltage, it becomes possible to reduce the scan pulse width as in the first and second embodiments.

As described above, the present embodiment also provides effects and advantages similar to those achieved by the second embodiment.

[Fourth Embodiment]

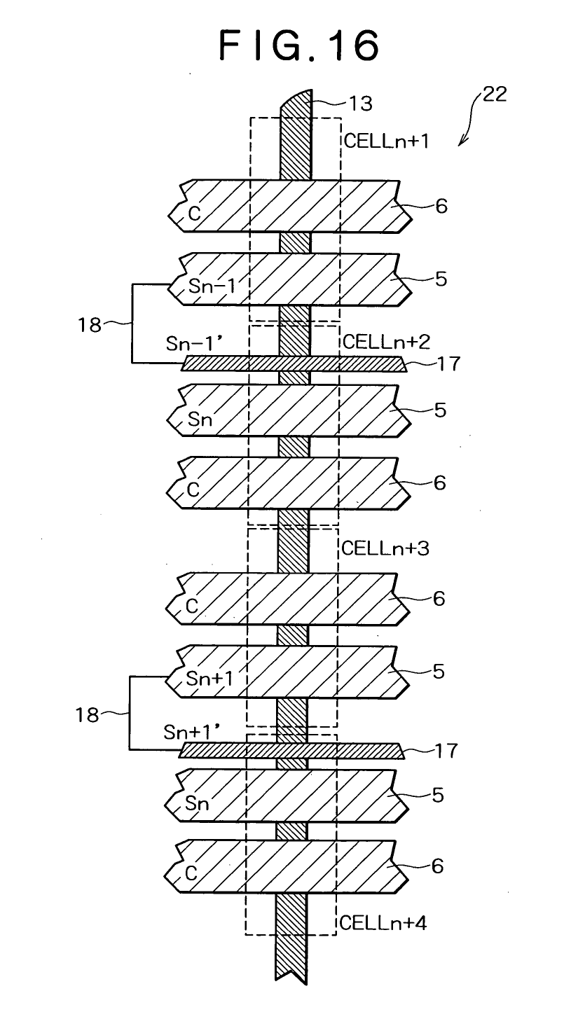

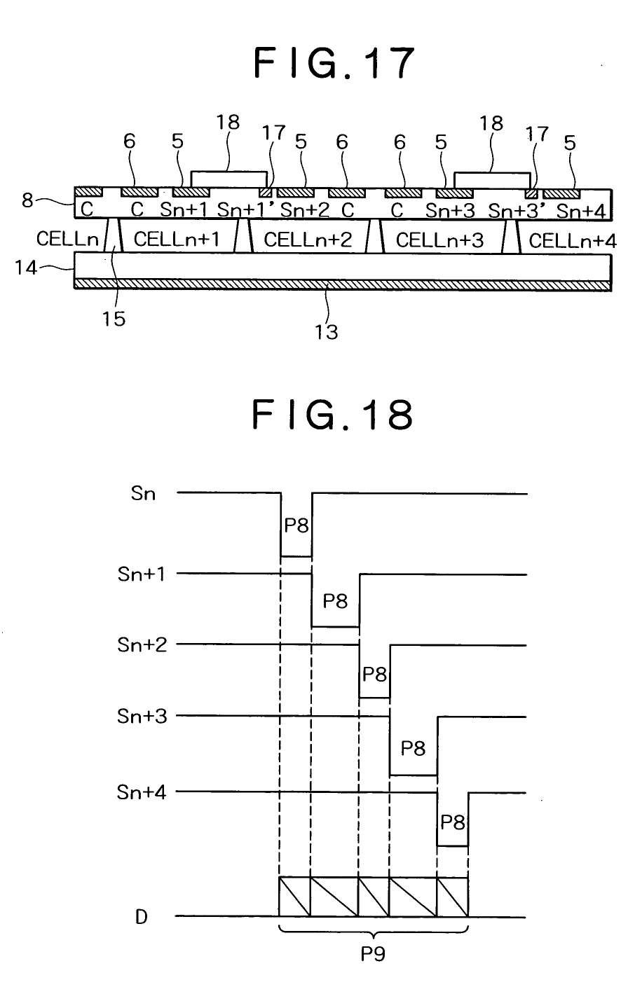

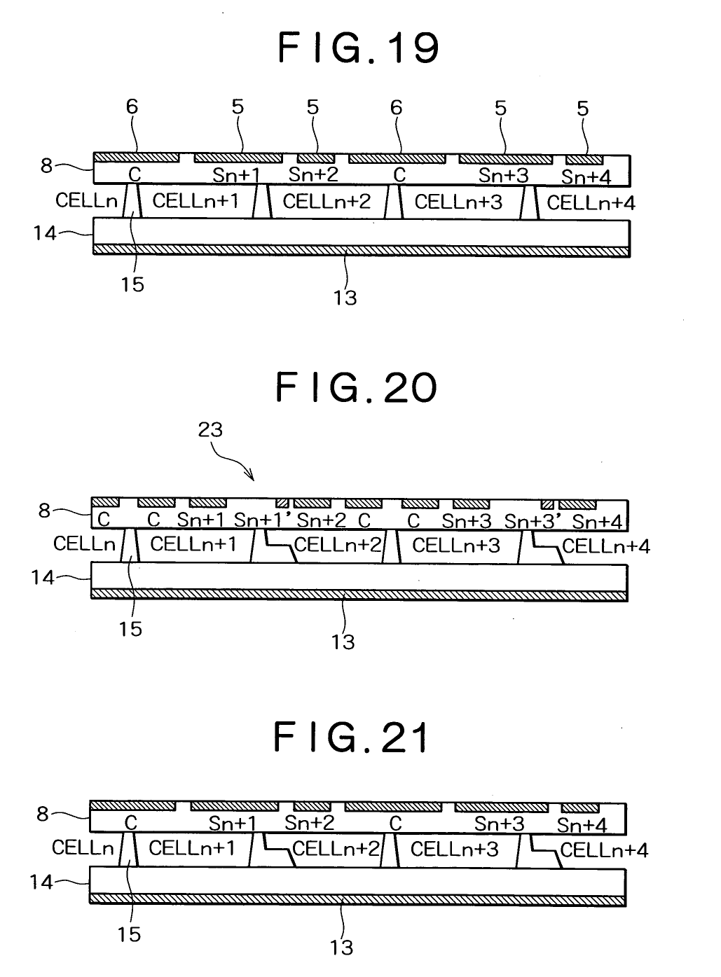

FIG. 16 is a plan view showing the structure of a PDP that is a main part of a plasma display according to a fourth embodiment of the present invention. FIG. 17 is a cross-sectional view of the PDP. FIG. 18 is a diagram showing the waveforms of pulse signals for driving the PDP according to the fourth embodiment, wherein the similar pulse signals are also used in the fifth and sixth embodiments. FIG. 19 is a side view showing a modification of the PDP according to the fourth embodiment. The structure of the PDP according to the present embodiment is essentially different from that according to the first embodiment in that a priming electrode is formed in every second cell of the cells disposed side by side in the column direction.

The manner of disposing electrodes of the PDP 22 is described below with reference to FIG. 16 taking, as examples for explanation, four cells (n+1), (n+2), (n+3), and (n+4) of the cells disposed in the column direction V. The cell (n+2) has a priming electrode 17 (Sn−1′) electrically connected via an interconnection 18 to a scan electrode 5 (Sn−1) of the cell (n+1) upwardly adjacent to the cell (n+2). The cell (n+4) has a priming electrode 17 (Sn+1′) electrically connected via an interconnection 18 to a scan electrode 5 (Sn+1) of the cell (n+3) upwardly adjacent to the cell (n+4). That is, in the PDP 22 according to the present embodiment, the scan electrode 5 of every second cell of the cells disposed side by side in the column direction V includes a part extending into an adjacent cell.

Referring to FIGS. 17 and 18, a method of driving the PDP according to the present embodiment is described below. Note that FIG. 18 shows driving signals only for a scan period (driving signals over a full subfield period is shown in FIG. 5). The write discharge in the cells n to (n+3) occurs in a scan period as follows. When the scan pulse is applied to the scan electrode 5 (Sn−1) of the cell (n+1), the cell (n+2) is brought into a priming discharge state because the scan electrode 5 (Sn−1) of the cell (n+1) is electrically connected to the priming electrode 17 (Sn−1′) of the cell (n+2). Because the scan pulse is applied to the cell (n+1) for a long period, a discharge occurs in the cell (n+1) regardless of a data pulse is applied to the data electrode of the cell (n+1). Because a priming discharge occurs in the cell (n+2) when the scan pulse is applied to the cell (n+1), a write discharge quickly occurs in the cell (n+2) when a scan pulse (Sn+2) is applied to the cell (n+2) even if the scan pulse (Sn+2) has a small pulse width.

Therefore, even when the scan pulse P8 applied to the scan electrode 5 (Sn+1) has a large pulse width, the total scan period can be reduced by reducing the pulse width of the scan pulse P8 applied to the scan electrode 5 (Sn+2). Similar effects are also achieved in the modified structure shown in FIG. 19 in which the scan electrode 5 (Sn+1) is connected with the priming electrode 17 (Sn+1′). Although in the modified structure shown in FIG. 19, the sustain electrode 6 of a cell is also connected to the sustain electrode of an adjacent cell, the sustain electrodes of adjacent cells may be electrically isolated as in the structure shown in FIG. 17.

As described above, the present embodiment also provides effects and advantages similar to those achieved by the first embodiment.

[Fifth Embodiment]

FIG. 20 is a side view showing the structure of a PDP that is a main part of a plasma display according to a fifth embodiment of the present invention. FIG. 21 is side view showing a modification of the PDP according to the fifth embodiment. The structure of the PDP according to the present embodiment is essentially different from that according to the fourth embodiment in that the structure is a combination of the structure according to the second embodiment and the structure according to the fourth embodiment.

That is, in the PDP 23 according to the present embodiment, as shown in FIG. 20, the structure in terms of electrodes is achieved by combining the structure according to the second embodiment shown in FIG. 14 and the structure according to the fourth embodiment shown in FIG. 17. The PDP 23 according to the present embodiment can be driven in a similar manner as in the fourth embodiment. That is, the pulse widths of scan pulses in a scan period are set such that the scan pulse P8 applied to the scan electrode 5 (Sn) connected to no priming electrode has a shorter pulse width than the pulse width of the scan pulse P8 applied to the scan electrode 5 (Sn−1) connected to the priming electrode 17 (Sn−1′). That is, although the scan pulse P8 applied to the scan electrode 5 (Sn+1) has a large pulse width, the total scan period can be reduced by reducing the pulse width of the scan pulse P8 applied to the scan electrode 5 (Sn+2). Similar effects are also achieved in the modified structure shown in FIG. 21 in which the scan electrode 5 (Sn+1) is connected with the priming electrode 17 (Sn+1′). Although in the modified structure shown in FIG. 21, the sustain electrode 6 of a cell is also connected to the sustain electrode of an adjacent cell, the sustain electrodes of adjacent cells may be electrically isolated as in the structure shown in FIG. 20.

As described above, the present embodiment also provides effects and advantages similar to those achieved by the fourth embodiment.

[Sixth Embodiment]

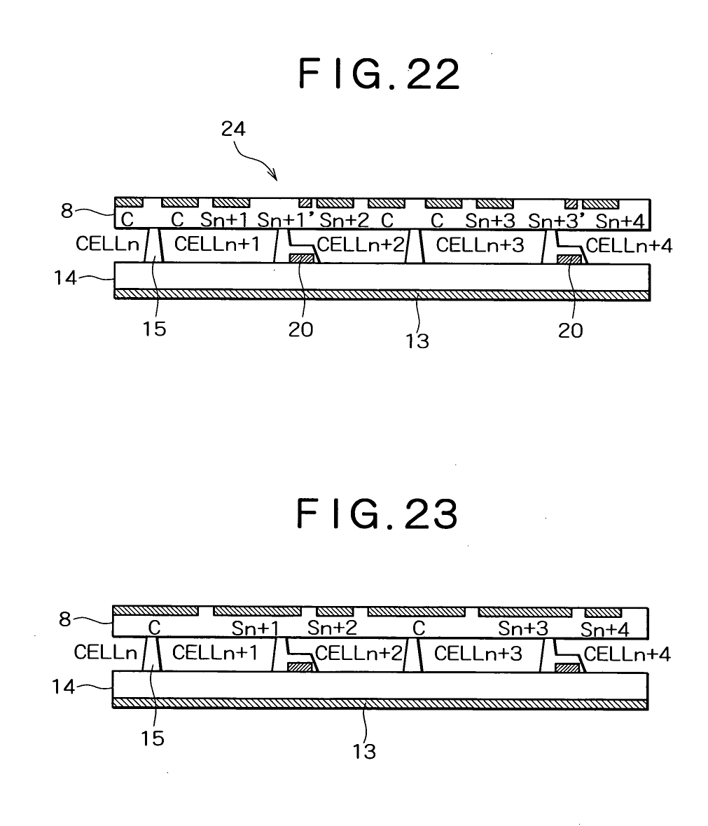

FIG. 22 is a side view showing the structure of a PDP that is a main part of a plasma display according to a sixth embodiment of the present invention. FIG. 23 is side view showing a modification of the PDP according to the sixth embodiment. The structure of the PDP according to the present embodiment is essentially different from that according to the fifth embodiment in that the structure is a combination of the structure according to the third embodiment and the structure according to the fifth embodiment.

That is, in the PDP 24 according to the present embodiment, as shown in FIG. 22, the structure in terms of electrodes is achieved by combining the structure according to the third embodiment shown in FIG. 15 and the structure according to the fifth embodiment shown in FIG. 20. The PDP 23 according to the present embodiment can be driven in a similar manner as in the fifth embodiment. That is, the pulse widths of scan pulses in a scan period are set such that the scan pulse P8 applied to the scan electrode 5 (Sn) having no priming electrode has a shorter pulse width than the pulse width of the scan pulse P8 applied to the scan electrode 5 (Sn−1) connected to the priming electrode 17 (Sn−1′). That is, although the scan pulse P8 applied to the scan electrode 5 (Sn+1) has a large pulse width, the total scan period can be reduced by reducing the pulse width of the scan pulse P8 applied to the scan electrode 5 (Sn+2). Similar effects are also achieved in the modified structure shown in FIG. 23 in which the scan electrode 5 (Sn+1) is connected with the priming electrode 17 (Sn+1′). Although in the modified structure shown in FIG. 23, the sustain electrode 6 of a cell is also connected to the sustain electrode of an adjacent cell, the sustain electrodes of adjacent cells may be electrically isolated as in the structure shown in FIG. 22.

As described above, the present embodiment also provides effects and advantages similar to those achieved by the fourth embodiment.

[Seventh Embodiment]

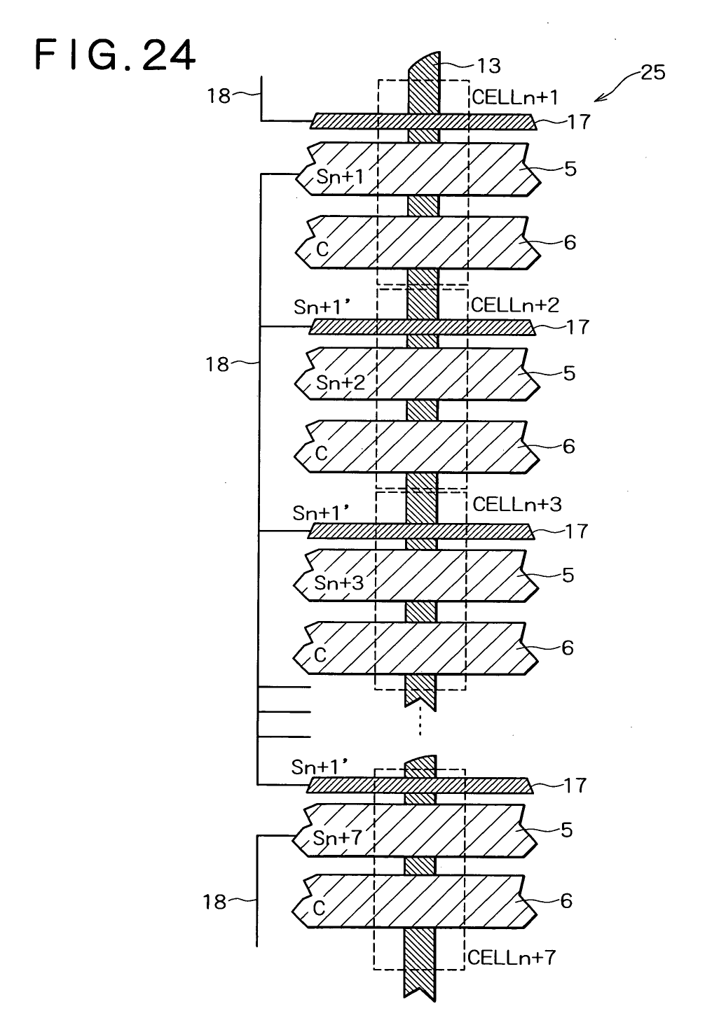

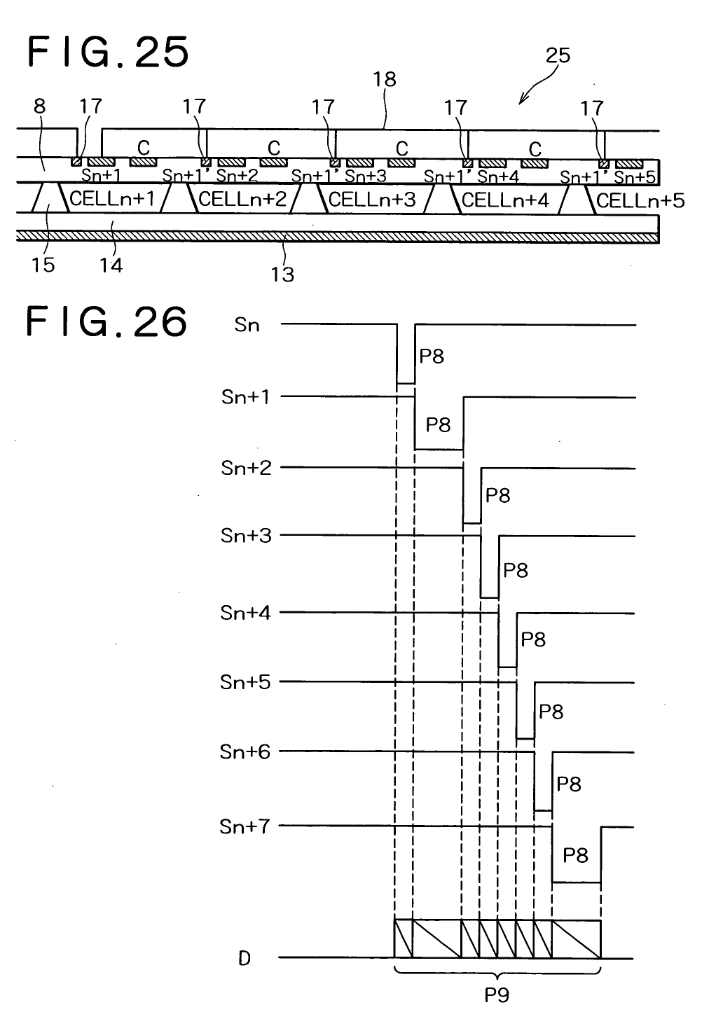

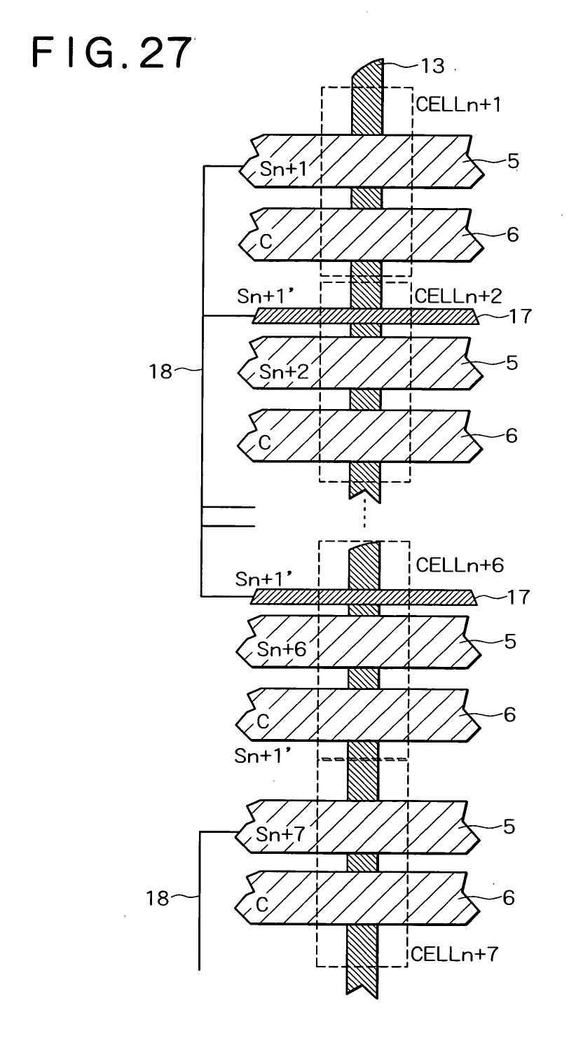

FIG. 24 is a plan view showing the structure of a PDP that is a main part of a plasma display according to a seventh embodiment of the present invention. FIG. 25 is a cross-sectional view of the PDP. FIG. 26 is a diagram showing the waveforms of pulse signals for driving the PDP according to the seventh embodiment, wherein the similar pulse signals are also used in the eighth and ninth embodiments. FIG. 27 is a side view showing a modification of the PDP according to the seventh embodiment. The structure of the PDP according to the present embodiment is essentially different from that according to the first embodiment in that a plurality of priming electrodes extend from a single scan electrode.

That is, in the PDP 25 according to the present embodiment, as shown in FIGS. 24 and 25, for example, a priming electrode 17 (Sn+1′) of a cell (n+2), a priming electrode 17 (Sn+2′) of a cell (n+3) and so on extend from a scan electrode 5 (Sn+1) of a cell (n+1). There is no particular limitation on the number of priming electrodes extending from a particular scan electrode.

A method of driving the PDP 24 according to the present embodiment is described below with reference to FIG. 26. In this embodiment, the scan pulse P8 applied to the scan electrode 17 (Sn+2) connected to no priming electrode has a shorter pulse width than the pulse width of the scan pulse P8 applied to the scan electrode 5 (Sn+1) connected to the priming electrodes 17 (Sn+1′), 17 (Sn+2′), and so on. The short pulse width of the scan pulse P8 does not necessarily need to be constant, but the pulse width may be varied. The process of driving the PDP 24 is described in further detail below taking cells (n+1) to (n+7) as examples. When the scan pulse P8 is applied to the scan electrode 5 (Sn+1) of the cell (n+1), the cells (n+2) to (n+7) are brought into a priming discharge state. Because the scan pulse P8 is applied to the cell (n+1) for a long period, a priming discharge occurs in each of the cells (n+2) to (n+7) regardless of whether or not the data pulse P9 is applied. Because the priming discharge is maintained for several tens ps, a write discharge occurs in response to the scan pulse P8 applied to the scan electrodes 5 (Sn+2) to (Sn+6) of the cells (n+2) to (n+7) even if the scan pulse P8 has a short pulse width. Therefore, even when the scan pulse P8 applied to the scan electrode 5 (Sn+1) has a rather large pulse width, the total scan period can be reduced by reducing the pulse width of the scan pulse P8 applied to the scan electrodes 5 (Sn+2) to (Sn+6). The structure according to the present embodiment may be modified as shown in FIG. 27. That is, the priming electrodes 17 extending from the scan electrode 5 (Sn+1) may be formed such that they extend into respective cells (n+2) to (n+5). In this modified structure, similar effects to those achieved in the embodiment described above can also be achieved.

As described above, the present embodiment also provides effects and advantages similar to those achieved by the first embodiment.

[Eighth Embodiment]

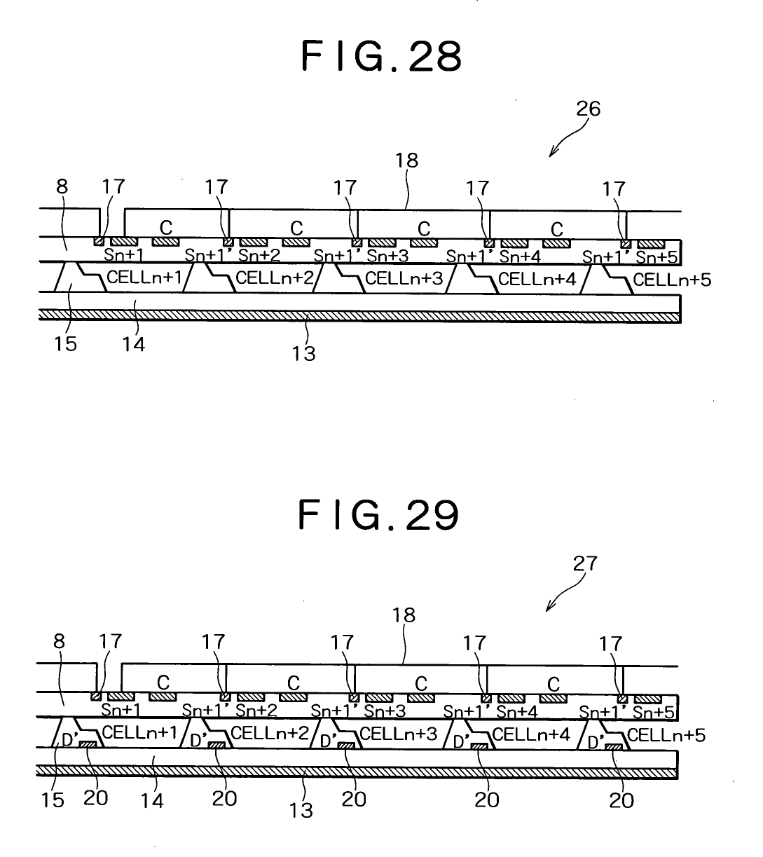

FIG. 28 is a side view showing the structure of a PDP that is a main part of a plasma display according to an eighth embodiment of the present invention. The structure of the PDP according to the present embodiment is essentially different from that according to the seventh embodiment in that the structure is a combination of the structure according to the second embodiment and the structure according to the seventh embodiment.

That is, in the PDP 26 according to the present embodiment, as shown in FIG. 28, the structure in terms of electrodes is achieved by combining the structure according to the seventh embodiment shown in FIG. 25 and the structure according to the second embodiment shown in FIG. 14. The PDP 25 according to the present embodiment can be driven in a similar manner as in the seventh embodiment. That is, the pulse widths of scan pulses in a scan period are set such that the scan pulse P8 applied to the scan electrode 17 (Sn+2) connected to no priming electrode has a shorter pulse width than the pulse width of the scan pulse P8 applied to the scan electrode 5 (Sn+1) connected to the priming electrodes 17 (Sn+1′), 17 (Sn+2′), and so on. The short pulse width of the scan pulse P8 does not necessarily need to be constant, but the pulse width may be varied. Therefore, even when the scan pulse P8 applied to the scan electrode 5 (Sn+1) has a rather large pulse width, the total scan period can be reduced by reducing the pulse width of the scan pulse P8 applied to the scan electrodes 5 (Sn+2) to (Sn+6). The priming electrodes 17 may be disposed such that, as shown in FIG. 27, the priming electrodes 17 starting from the scan electrode 5 (Sn+1) extend into respective cells (n+2) to (n+5). In this modified structure, similar effects to those achieved in the embodiment described above can also be achieved.

As described above, the present embodiment also provides effects and advantages similar to those achieved by the seventh embodiment.

[Ninth Embodiment]

FIG. 29 is a side view showing the structure of a PDP that is a main part of a plasma display according to a ninth embodiment of the present invention. The structure of the PDP according to the present embodiment is essentially different from that according to the eighth embodiment in that the structure is a combination of the structure according to the third embodiment and the structure according to the eighth embodiment.

That is, in the PDP 27 according to the present embodiment, as shown in FIG. 29, the structure in terms of electrodes is achieved by combining the structure according to the eighth embodiment shown in FIG. 28 and the structure according to the third embodiment shown in FIG. 15. The PDP 27 according to the present embodiment can be driven in a similar manner as in the eighth embodiment. That is, the pulse widths of scan pulses in a scan period are set such that the scan pulse P8 applied to the scan electrode 17 (Sn+2) connected to no priming electrode has a shorter pulse width than the pulse width of the scan pulse P8 applied to the scan electrode 5 (Sn+1) connected to the priming electrodes 17 (Sn+1′), 17 (Sn+2′), and so on. The short pulse width of the scan pulse P8 does not necessarily need to be constant, but the pulse width may be varied. That is, although the scan pulse P8 applied to the scan electrode 5 (Sn+1) has a large pulse width, the total scan period can be reduced by reducing the pulse width of the scan pulse P8 applied to the scan electrodes 5 (Sn+2) to (Sn+6). The priming electrodes 17 may be disposed such that, as shown in FIG. 27, the priming electrodes 17 starting from the scan electrode 5 (Sn+1) extend into respective cells (n+2) to (n+5). In this modified structure, similar effects to those achieved in the embodiment described above can also be achieved.

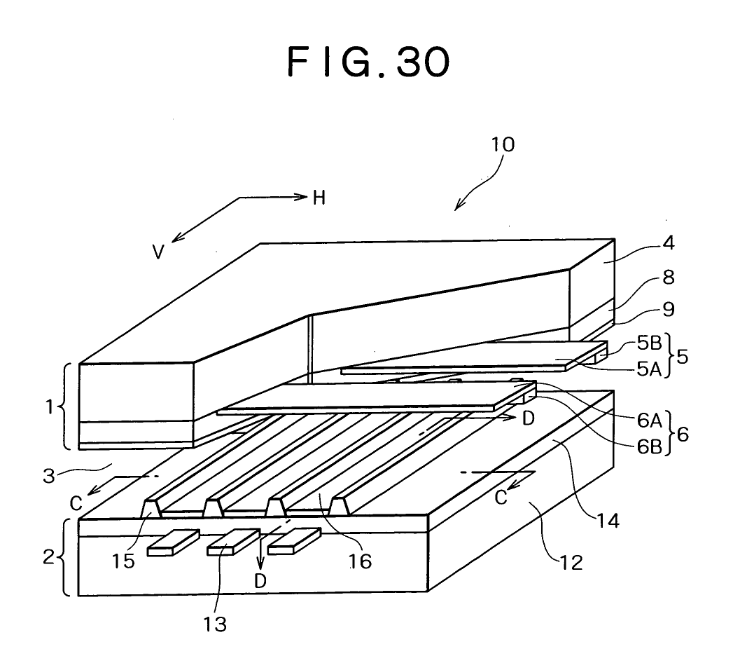

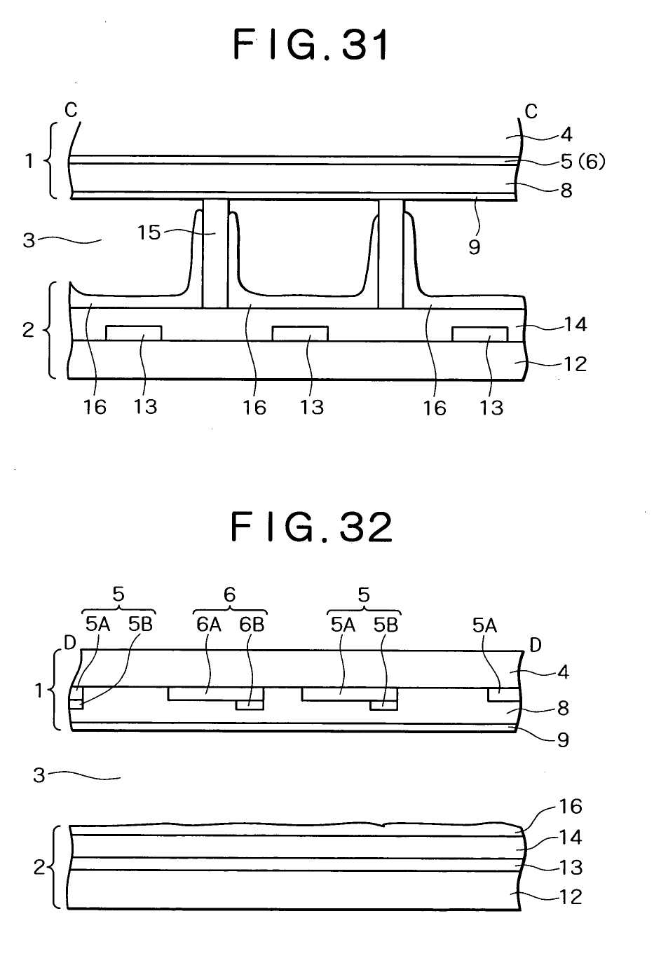

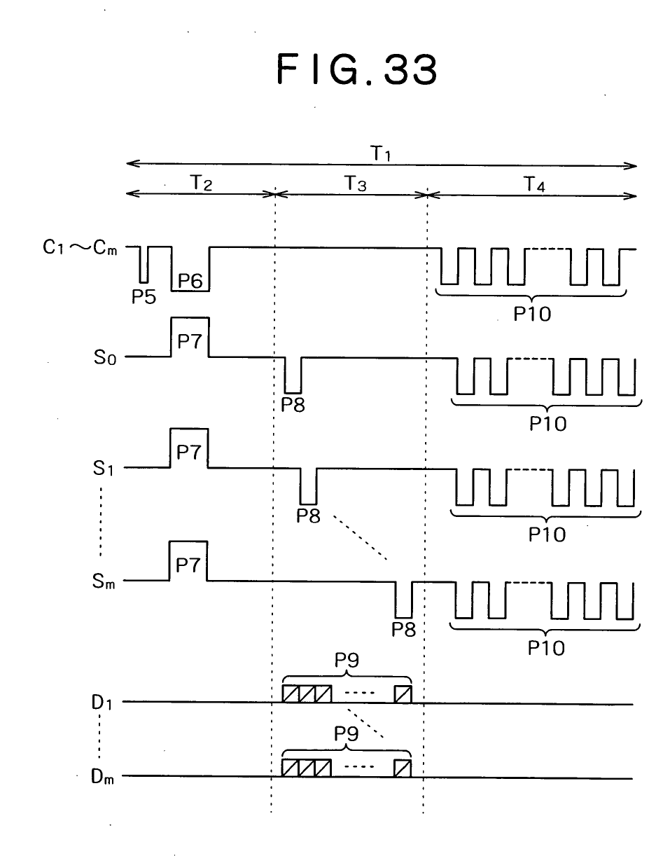

The present invention has been described above with reference to particular embodiments in conjunction with the accompanying drawings. Note that the present invention is not limited to details of those embodiments, but various modifications in structure and/or design are possible without departing from the spirit and scope of the invention. For example, although in the embodiments described above, the partition walls 15 on rear substrate 2 are formed such that rectangular discharge spaces enclosed in the partition walls 15 are formed, the partition walls 15 may be formed so as to simply extend in the form of stripes as shown in FIGS. 30 to 32. Furthermore, although in the embodiments described above, scan electrodes and sustain electrodes are alternately disposed, scan electrodes and sustain electrodes may be disposed in a different manner as long as the objects of the present invention can be achieved.

In the structure of the PDP in which, as in the first to third embodiment and as in the seventh to ninth embodiments, a priming electrode is provided in the first row and a cell (n−1) is in the first row (hereinafter, this cell (n−1) is referred to as a cell 1 because it is located in the first row) as shown in FIG. 11, the priming electrode SO of the this cell 1 is independent of any other scan electrodes, that is, the priming electrode SO is not connected to the scan electrode of any cell. In this structure, when the cell in the first row is driven, if a scan pulse to applied to the priming electrode So before a scan pulse is applied to the scan electrode (Si) of the cell 1 in the first row as shown in FIG. 33, it is possible to reduce the pulse width of the scan pulse for all cells. Alternatively, no scan pulse may be applied to the priming electrode So. In this case, the priming electrode SO does not have a contribution to a priming discharge in the cell 1. However, because the scan pulse P8 is applied to the cell 1 shortly after the application of priming voltages P6 and P7, a priming discharge can occur. Therefore, even when the pulse width of the scan pulse is set to be short for all cells, a write discharge can occur even in cells in the first row.

In any embodiment described above, if all priming electrodes extending from any scan electrode are formed such that they are not viewed from the display surface, that is, if light due to priming discharges is blocked, improved contrast can be achieved, in particular, in the second, third, fifth, sixth, eighth, and ninth embodiments. That is, high contrast can be achieved by forming the priming electrodes using a metallic material such as silver which is opaque to visible light. In the case in which the priming electrodes are formed of a transparent material such as ITO, a light blocking part may be formed on the front substrate to achieve high contrast.

1. A plasma display comprising: a plasma display panel, said plasma display panel comprising:
first and second substrates disposed so as to face each other via a discharge space filled with a discharge gas;
row electrodes each including a scan electrode and a sustain electrode formed on the inner surface of the first substrate so as to extend in parallel in a row direction;
data electrodes formed on the inner surface of the second substrate so as to extend in a column direction perpendicular to the row direction; and
unit cells formed at respective intersections of the row electrodes and the column electrodes, at least one unit cell of the unit cells having an auxiliary electrode electrically connected to a scan electrode of another unit cell disposed in the same column as the column in which the at least one unit cell lies.

2. The plasma display according to claim 1, wherein at least one unit cell of the unit cells has an auxiliary electrode electrically connected to a scan electrode of another unit cell adjacent in the column direction to the at least one unit cell.

3. The plasma display according to claim 1, wherein each of the unit cells other than unit cells located in a top row has a scan electrode, a sustain electrode, a data electrode, and an auxiliary electrode.

4. The plasma display according to claim 1, wherein each of unit cells located in a top row has a scan electrode, a sustain electrode, a data electrode, and an auxiliary electrode, the auxiliary electrode being independent of any other electrode unlike the auxiliary electrode of unit cells other than those located in the top row.

5. The plasma display according to claim 1, wherein a dielectric layer formed on the second substrate has a greater thickness at locations opposing the auxiliary electrodes formed on the first substrate than at locations opposing the scan electrodes formed on the first substrate.

6. The plasma display according to claim 5, wherein a common cell electrode is formed, separately from the data electrode, in the dielectric layer at each location opposing each auxiliary electrode.

7. The plasma display according to claim 1, wherein the auxiliary electrodes are formed such that a plurality of auxiliary electrodes extend from the scan electrode of one unit cell and extend into a plurality of other unit cells.

8. The plasma display according to claim 1, wherein the auxiliary electrodes are formed of an opaque metal.

9. The plasma display according to claim 1, wherein a light blocking member is provided on the upper side of the auxiliary electrodes.

10. A method of driving a plasma display panel, which comprises first and second substrates disposed so as to face each other via a discharge space filled with a discharge gas, row electrodes each including a scan electrode and a sustain electrode formed on the inner surface of the first substrate so as to extend in parallel in a row direction, data electrodes formed on the inner surface of the second substrate so as to extend in a column direction perpendicular to the row direction, and unit cells formed at respective intersections of the row electrodes and the column electrodes, wherein at least one unit cell of the unit cells has an auxiliary electrode electrically connected to a scan electrode of another unit cell adjacent in the column direction to the at least one unit cell,
the method including the step of
applying a scan pulse to a scan electrode such that the scan pulse applied to the scan electrode of a unit cell causes a voltage greater than a discharge firing voltage to be developed between the auxiliary electrode and one of electrodes of each of all unit cells whose auxiliary electrode is electrically connected to the cell whose scan electrode is applied with the scan pulse, regardless of whether or not a data pulse is applied to the data electrode.

11. A method of driving a plasma display panel, which comprises first and second substrates disposed so as to face each other via a discharge space filled with a discharge gas, row electrodes each including a scan electrode and a sustain electrode formed on the inner surface, facing the second substrate, of the first substrate so as to extend in parallel in a row direction, data electrodes formed on the inner surface, facing the first substrate, of the second substrate so as to extend in a column direction perpendicular to the row direction, and unit cells formed at respective intersections of the row electrodes and the column electrodes, wherein at least one unit cell of the unit cells has an auxiliary electrode electrically connected to a scan electrode of another unit cell adjacent in the column direction to the at least one unit cell,
the method including the step of
scanning an arbitrary row by applying a scan pulse to a scan electrode in the row such that the scan pulse applied to the scan electrode of a unit cell causes a voltage greater than a discharge firing voltage to be developed between the auxiliary electrode and one of electrodes of each unit cell whose auxiliary electrode is electrically connected to the cell whose scan electrode is applied with the scan pulse, regardless of whether or not a data pulse is applied to the data electrode.

12. The method of driving a plasma display panel according to claim 10, wherein the discharge firing voltage between an auxiliary electrode and a corresponding data electrode is smaller than the discharge firing voltage between a scan electrode and a corresponding data electrode.

13. The method of driving a plasma display panel according to claim 11, wherein the discharge firing voltage between an auxiliary electrode and a corresponding data electrode is smaller than the discharge firing voltage between a scan electrode and a corresponding data electrode.

14. The method of driving a plasma display panel according to claim 10, wherein the voltage of the scan pulse is set such that the scan pulse applied to the scan electrode of a unit cell causes a discharge to occur between the auxiliary electrode and one of electrodes of each of all unit cells whose auxiliary electrode is electrically connected to the cell whose scan electrode is applied with the scan pulse, regardless of whether or not a data pulse is applied to the data electrode.

15. The method of driving a plasma display panel according to claim 11, wherein the voltage of the scan pulse is set such that the scan pulse applied to the scan electrode of a unit cell causes a discharge to occur between the auxiliary electrode and one of electrodes of each of all unit cells whose auxiliary electrode is electrically connected to the cell whose scan electrode is applied with the scan pulse, regardless of whether or not a data pulse is applied to the data electrode.

16. The method of driving a plasma display panel according to claim 10, wherein the rows are grouped into a plurality of groups each including two or more scan rows in the row direction such that in any block, a scan electrode in a row to which data is written first of all rows in the block functions not only as a write electrode for writing data in that row but also as an auxiliary electrode for cells in all rows in the block.

17. The method of driving a plasma display panel according to claim 11, wherein the rows are grouped into a plurality of groups each including two or more scan rows in the row direction such that in any block, a scan electrode in a row to which data is written first of all rows in the block functions not only as a write electrode for writing data in that row but also as an auxiliary electrode for cells in all rows in the block.

18. The method of driving a plasma display panel according to claim 14, wherein a scan pulse is applied to a scan electrode connected to an auxiliary electrode for a longer period than is applied to a scan electrode in a block in which the auxiliary electrode lies.

19. The method of driving a plasma display panel according to claim 15, wherein a scan pulse is applied to a scan electrode connected to an auxiliary electrode for a longer period than is applied to a scan electrode in a block in which the auxiliary electrode lies.
